(19) United States
(12) Patent Application Publication
(10) Pub. No.: US 2026/0178895 A1
(43) Pub. Date: Jun. 25, 2026

(54) NEURAL NETWORK CIRCUIT AND NEURAL NETWORK OPERATION METHOD

(71) Applicant: Maxell, Ltd., Kyoto (JP)

(72) Inventor: Kenji WATANABE, Tokyo (JP)

(21) Appl. No.: 19/124,693

(22) PCT Filed: Dec. 15, 2022
(86) PCT No.: PCT/JP2022/046214

§ 371 Date: Apr. 25, 2025

(30) Foreign Application Priority Data
Jan. 24, 2022 (JP) 2022-008692

(51) Int. Cl. G06N 3/063; G06N 3/04; G06N 3/08; G06V 10/82

(52) U.S. Cl. CPC G06N 3/063; G06N 3/04; G06N 3/08; G06V 10/82

(57) ABSTRACT

A neural network circuit having multiple neural network operation cores having convolution operation circuits that perform convolution operations and quantization operation circuits that perform quantization operations, wherein the multiple neural network operation cores are connected so as to be able to input and output data.

### CROSS-REFERENCE TO RELATED APPLICATIONS

This application is the U.S. National Stage entry of International Application No. PCT/JP2022/046214, filed on Dec. 15, 2022, which, in turn, claims priority to JP Patent Application No. 2022-008692, filed on Jan. 24, 2022, both of which are hereby incorporated herein by reference in their entireties for all purposes.

### TECHNICAL FIELD

The present invention relates to a neural network circuit and a neural network operation method.

### BACKGROUND ART

In recent years, convolutional neural networks (CNN) have been used as models for image recognition and the like. Convolutional neural networks have a multilayered structure with convolutional layers and pooling layers, and require many operations such as convolution operations. Various operation processes that accelerate operations by convolutional neural networks have been proposed (e.g., Patent Document 1).

### CITATION LIST

### Patent Document

Patent Document 1: Japanese Unexamined Patent Application, First Publication No. 2018-077829

### SUMMARY OF INVENTION

### Technical Problem

Meanwhile, there is a desire to realize image recognition and the like by utilizing convolutional neural networks in embedded devices such as IoT devices. Large-scale dedicated circuits as described in Patent Document 1, etc. are difficult to embed in embedded devices. Additionally, in embedded devices with limited hardware resources such as CPU or memory, sufficient operational performance is difficult to realize in convolutional neural networks by means of software alone.

In consideration of the above-mentioned circumstances, an objective of the present invention is to provide a high-performance neural network circuit and neural network operation method that are embeddable in an embedded device such as an IoT device.

### Solution to Problem

In order to solve the above-mentioned problems, the present invention proposes the means indicated below.

A neural network circuit according to a first embodiment of the present invention has multiple neural network operation cores having convolution operation circuits that perform convolution operations and quantization operation circuits that perform quantization operations, wherein the multiple neural network operation cores are connected so as to be able to input and output data.

A neural network operation method according to a second embodiment of the present invention is a neural network operation method using a first neural network operation core and a second neural network operation core, the neural network operation method including switching output data from the first neural network operation core between a loop-back data flow for looping back to the first neural network operation core, and a bypass data data flow for bypassing the second neural network operation core.

### Advantageous Effects of Invention

The neural network circuit and the neural network operation method of the present invention have high performance and are embeddable in an embedded device such as an IoT device.

### BRIEF DESCRIPTION OF DRAWINGS

FIG. 1 is a diagram illustrating a convolutional neural network.

FIG. 2 is a diagram for explaining a convolution operation performed by a convolution layer.

FIG. 3 is a diagram for explaining data expansion in a convolution operation.

FIG. 4 is a diagram illustrating the overall structure of a neural network circuit according to a first embodiment.

FIG. 5 is a diagram illustrating the overall structure of an NN operation core.

FIG. 6 is a timing chart indicating an operational example of the NN operation core.

FIG. 7 is a timing chart indicating another operational example of the NN operation core.

FIG. 8 is a diagram illustrating an NN operation multi-core.

FIG. 9 is a timing chart indicating an operational example of the NN operation multi-core.

FIG. 10 is a timing chart indicating another operational example of the NN operation multi-core.

FIG. 11 is a timing chart indicating another operational example of the NN operation multi-core.

FIG. 12 is an internal block diagram of a DMAC in the neural network circuit.

FIG. 13 is a state transition diagram of a control circuit in the DMAC.

FIG. 14 is an internal block diagram of a convolution operation circuit in the neural network circuit.

FIG. 15 is an internal block diagram of a multiplier in the convolution operation circuit.

FIG. 16 is an internal block diagram of a multiply-add operation unit in the multiplier.

FIG. 17 is an internal block diagram of an accumulator circuit in the convolution operation circuit.

FIG. 18 is an internal block diagram of an accumulator unit in the accumulator circuit.

FIG. 19 is an internal block diagram of a quantization operation circuit in the neural network circuit.

FIG. 20 is an internal block diagram of a vector operation circuit and a quantization circuit in the quantization operation circuit.

FIG. 21 is a block diagram of an operation unit.

FIG. 22 is an internal block diagram of a vector quantization unit in the quantization circuit.

FIG. 23 is a diagram for explaining control of the neural network circuit by semaphores.

FIG. 24 is a timing chart of a first data flow.

FIG. 25 is a timing chart of a second data flow.

FIG. 26 is a timing chart of the first data flow.

FIG. 27 is a timing chart of the second data flow.

FIG. 28 is an internal block diagram of a convolution operation circuit in a neural network circuit according to a second embodiment.

FIG. 29 is an internal block diagram of a multiplier in the convolution operation circuit.

FIG. 30 is an internal block diagram of a multiply-add operation unit array in the multiplier.

FIG. 31 is an internal block diagram of a multiply-add operation unit in the multiply-add operation unit array.

FIG. 32 is a diagram illustrating the overall structure of a neural network circuit according to a third embodiment.

FIG. 33 is an internal block diagram of a first DMAC in the neural network circuit.

FIG. 34 is a timing chart indicating the operations of a clock control unit in the first DMAC, etc.

FIG. 35 is an internal block diagram of a convolution operation circuit in the neural network circuit.

FIG. 36 is an internal block diagram of a quantization operation circuit in the neural network circuit.

FIG. 37 is a diagram illustrating the overall structure of a neural network circuit according to a fourth embodiment.

### DESCRIPTION OF EMBODIMENTS

### First Embodiment

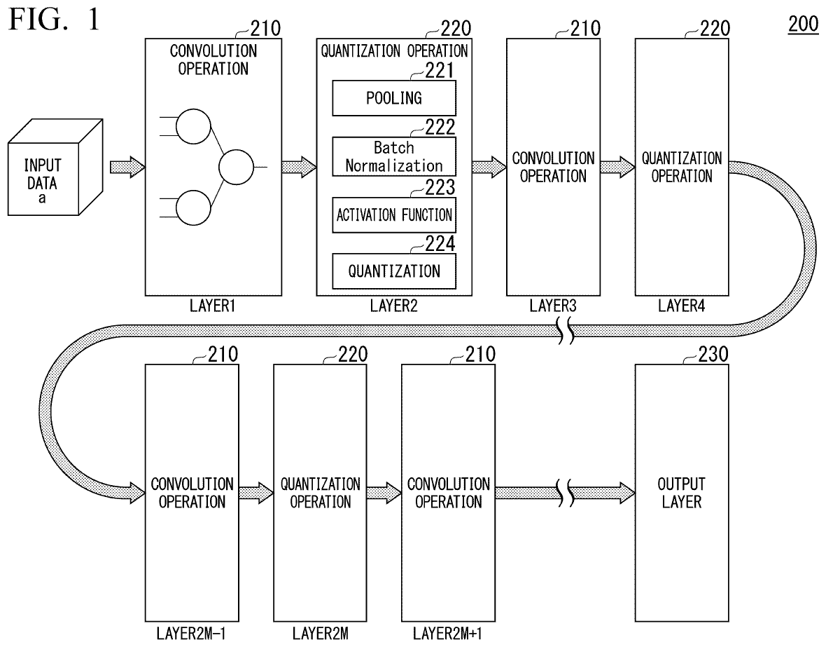

A first embodiment of the present invention will be explained with reference to FIG. 1 to FIG. 27.

FIG. 1 is a diagram illustrating a convolutional neural network 200 (hereinafter referred to as “CNN 200”). The operations performed by the neural network circuit 100 (hereinafter referred to as “NN circuit 100”) according to the first embodiment constitute at least part of a trained CNN 200, which is used at the time of inference.

### [CNN 200]

The CNN 200 is a network having a multilayered structure, including convolution layers 210 that perform convolution operations, quantization operation layers 220 that perform quantization operations, and an output layer 230. In at least part of the CNN 200, the convolution layers 210 and the quantization operation layers 220 are connected in an alternating manner. The CNN 200 is a model that is widely used for image recognition and video recognition. The CNN 200 may further have a layer with another function, such as a fully connected layer.

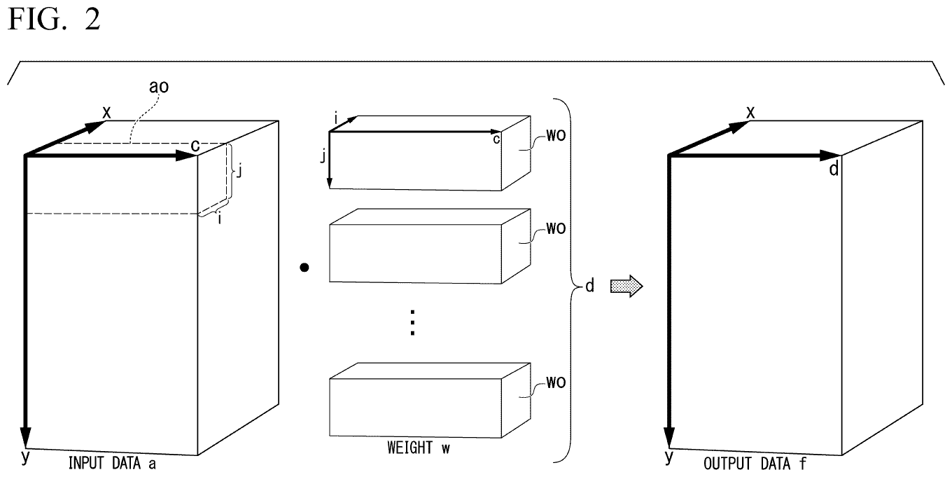

FIG. 2 is a diagram for explaining the convolution operations performed by the convolution layers 210.

The convolution layers 210 perform convolution operations in which weights w are used on input data a. The convolution layers 210 perform multiply-add operations using the input data a and the weights w as input.

The input data a (also referred to as activation data or a feature map) that is input to the convolution layers 210 is multi-dimensional data such as image data. In the present embodiment, the input data a is a three-dimensional tensor comprising elements (x, y, c). The convolution layers 210 in the CNN 200 perform convolution operations on low-bit input data a. In the present embodiment, the elements of the input data a are 2-bit unsigned integers (0, 1, 2, 3). The elements of the input data a may, for example, be 4-bit or 8-bit unsigned integers.

If the input data that is input to the CNN 200 is in a form different from that of the input data a input to the convolution layers 210, e.g., of the 32-bit floating-point type, then the CNN 200 may further have an input layer for performing type conversion or quantization in front of the convolution layers 210.

The weights w (also referred to as filters or kernels) in the convolution layers 210 are multi-dimensional data having elements that are learnable parameters. In the present embodiment, the weights w are four-dimensional tensors comprising the elements (i, j, c, d). The weights w include d three-dimensional tensors (hereinafter referred to as “weights wo”) having the elements (i, j, c). The weights w in a trained CNN 200 are learned data. The convolution layers 210 in the CNN 200 use low-bit weights w to perform convolution operations. In the present embodiment, the elements of the weights w are 1-bit signed integers (0, 1), where the value “0” represents +1 and the value “1” represents −1.

The convolution layers 210 perform the convolution operation indicated in Equation 1 and output the output data f In Equation 1, s indicates a stride. The region indicated by the dotted line in FIG. 2 indicates one region ao (hereinafter referred to as “application region ao”) in which the weights wo are applied to the input data a. The elements of the application region ao can be represented by (x+i, y+j, c).

$$f ( x , y , d ) = {\sum }_{i}^{K} {\sum }_{i}^{K} {\sum }_{c}^{C} a ( s \cdot x + i , s \cdot y + j , c ) \cdot w ( i , j , c , d ) \qquad [ Equation 1 ]$$

The quantization operation layers 220 implement quantization or the like on the convolution operation outputs that are output by the convolution layers 210. The quantization operation layers 220 each have a pooling layer 221, a batch normalization layer 222, an activation function layer 223, and a quantization layer 224.

The pooling layer 221 implements operations such as average pooling (Equation 2) and max pooling (Equation 3) on the convolution operation output data f output by a convolution layer 210, thereby compressing the output data f from the convolution layer 210. In Equation 2 and Equation 3, u indicates an input tensor, v indicates an output tensor, and T indicates the size of a pooling region. In Equation 3, max is a function that outputs the maximum value of u for combinations of i and j contained in T.

$$v ( x , y , c ) = \frac{1}{{T}^{2}} {\sum }_{i}^{T} {\sum }_{j}^{T} u ( T \cdot x + i , T \cdot y + j , c ) \qquad [ Equation 2 ]$$

$$v ( x , y , c ) = max ( u ( T \cdot x + i , T \cdot y + j , c ) ) , i ∈ T , j ∈ T \qquad [ Equation 3 ]$$

The batch normalization layer 222 normalizes the data distribution of the output data from a quantization operation layer 220 or a pooling layer 221 by means of an operation as indicated, for example, by Equation 4. In Equation 4, u indicates an input tensor, v indicates on output tensor, α indicates a scale, and β indicates a bias. In a trained CNN 200, α and β are learned constant vectors.

$$v ( x , y , c ) = α ( c ) \cdot ( u ( x , y , c ) - β ( c ) ) \qquad [ Equation 4 ]$$

The activation function layer 223 performs activation function operations such as ReLU (Equation 5) on the output from a quantization operation layer 220, a pooling layer 221, or a batch normalization layer 222. In Equation 5, u is an input tensor and v is an output tensor. In Equation 5, max is a function that outputs the argument having the highest numerical value.

$$v ( x , y , c ) = max ( 0 , u ( x , y , c ) ) \qquad [ Equation 5 ]$$

The quantization layer 224 performs quantization as indicated, for example, by Equation 6, on the outputs from a pooling layer 221 or an activation function layer 223, based on quantization parameters. The quantization indicated by Equation 6 reduces the bits in an input tensor u to 2 bits. In Equation 6, q(c) is a quantization parameter vector. In a trained CNN 200, q(c) is a learned constant vector. In Equation 6, the inequality sign “≤” may be replaced with “<”.

$$\begin{matrix}qtz ( x , y , c ) = 0 & if u ( x , y , c ) ≦ q ( c ) . th 0 & else \\ 1 & if u ( x , y , c ) ≦ q ( c ) . th 1 & else \\ 2 & if u ( x , y , c ) ≦ q ( c ) . th 2 & else \\ 3 & & \end{matrix} \qquad [ Equation 6 ]$$

The output layer 230 is a layer that outputs the results from the CNN 200 by means of an identity function, a softmax function or the like. The layer preceding the output layer 230 may be either a convolution layer 210 or a quantization operation layer 220.

In the CNN 200, quantized output data from the quantization layers 224 are input to the convolution layers 210. Thus, the load of the convolution operations by the convolution layers 210 is smaller than that in other convolutional neural networks in which quantization is not performed.

### [Partitioning of Convolution Operations]

The NN circuit 100 performs operations by partitioning the input data to the convolution operations (Equation 1) in the convolution layers 210 into partial tensors. The partitioning method and the number of partitions of the partial tensors are not particularly limited. The partial tensors are formed, for example, by partitioning the input data a(x+i, y+j, c) into a(x+i, y+j, co). The NN circuit 100 can also perform operations on the input data to the convolution operations (Equation 1) in the convolution layers 210 without partitioning the input data.

When the input data to a convolution operation is partitioned, the variable c in Equation 1 is partitioned into blocks of size Bc, as indicated by Equation 7. Additionally, the variable din Equation 1 is partitioned into blocks of size Bd, as indicated by Equation 8. In Equation 7, co is an offset, and ci is an index from 0 to (Bc−1). In Equation 8, do is an offset, and di is an index from 0 to (Bd−1). The size Bc and the size Bd may be the same.

$$c = co \cdot Bc + ci \qquad [ Equation 7 ]$$

$$d = do \cdot Bd + di \qquad [ Equatio n 8 ]$$

The input data a(x+i, y+j, c) in Equation 1 is partitioned into the size Bc in the c-axis direction and is represented as the partitioned input data a(x+i, y+j, co). In the explanation below, input data a that has been partitioned is also referred to as “partitioned input data a”.

The weight w(i, j, c, d) in Equation 1 is partitioned into the size Bc in the c-axis direction and into the size Bd in the d-axis direction, and is represented as the partitioned weight w(i, j, co, do). In the explanation below, a weight w that has been partitioned will also referred to as a “partitioned weight w”.

The output data f(x, y, do) partitioned into the size Bd is determined by Equation 9. The final output data f(x, y, d) can be computed by combining the partitioned output data f(x, y, do).

$$[ Equation 9 ]$$

$$f ( x , y , do ) = {\sum }_{i}^{K} {\sum }_{j}^{K} {\sum }_{co}^{C / Bc} a ( s \cdot x + i , s \cdot y + j , co ) \cdot w ( i , j , co , do )$$

### [Expansion of Convolution Operation Data]

The NN circuit 100 performs convolution operations by expanding the input data a and the weights w in the convolution operations by the convolution layers 210.

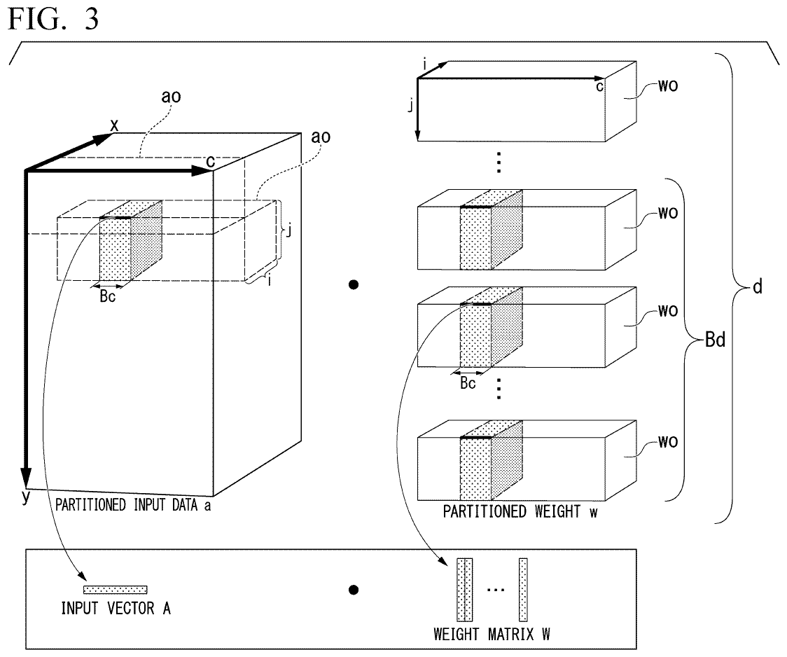

FIG. 3 is a diagram explaining the expansion of the convolution operation data.

The partitioned input data a(x+i, y+j, co) is expanded into vector data having Bc elements. The elements in the partitioned input data a are indexed by ci (where 0≤ci<Bc). In the explanation below, partitioned input data a expanded into vector data for each of i and j will also be referred to as “input vector A”. An input vector A has elements from partitioned input data a(x+i, y+j, co×Bc) to partitioned input data a(x+i, y+j, co×Bc+(Bc−1)).

The partitioned weights w(i, j, co, do) are expanded into matrix data having Bc×Bd elements. The elements of the partitioned weights w expanded into matrix data are indexed by ci and di (where 0≤di<Bd). In the explanation below, a partitioned weight w expanded into matrix data for each of i and j will also be referred to as a “weight matrix W”. A weight matrix W has elements from a partitioned weight w(i, j, co×Bc, do×Bd) to a partitioned weight w(i, j, co×Bc+(Bc−1), do×Bd+(Bd−1)).

Vector data is computed by multiplying an input vector A with a weight matrix W. Output data f(x, y, do) can be obtained by formatting vector data computed for each of i, j, and co as a three-dimensional tensor. By expanding the data in this manner, the convolution operations in the convolution layers 210 can be implemented by multiplying vector data with matrix data.

### [NN Circuit 100]

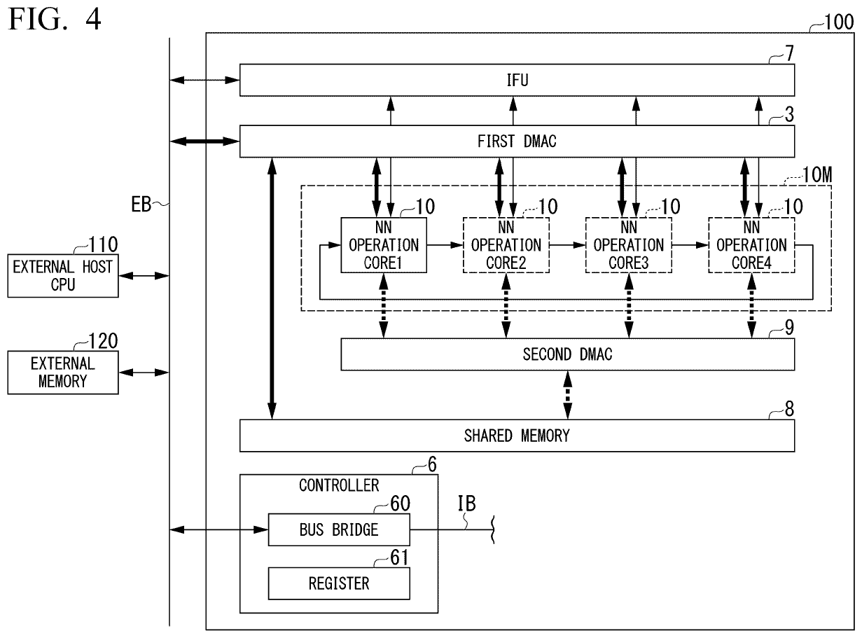

FIG. 4 is a diagram illustrating the overall structure of the NN circuit 100 according to the present embodiment.

The NN circuit 100 is provided with a first DMA controller 3 (hereinafter also referred to as “first DMAC 3”), a controller 6, an IFU 7, a shared memory 8, a second DMA controller 9 (hereinafter also referred to as “second DMAC 9”), and at least one neural network operation core 10 (hereinafter also referred to as “NN operation core 10”).

Multiple NN operation cores 10 can be mounted on the NN circuit 100. In the NN circuit 100 indicated in FIG. 4, a maximum of four NN operation cores 10 can be mounted. The multiple NN operation cores 10 form a “neural network operation multi-core 10M (hereinafter also referred to as ‘NN operation multi-core 10M’)” that cooperate to execute at least some of the operations of the NN 200. The multiple NN operation cores 10 are connected in a daisy chain in the present embodiment. The number of NN operation cores 10 that can be mounted on the NN circuit 100 may be five or more.

The first DMAC 3 is connected to an external bus EB and transfers data between an external memory 120, such as a DRAM, and the NN operation cores 10. The first DMAC 3 transfers data read out from the external memory 120 to one of the multiple NN operation cores 10. The first DMAC 3 may be able to broadcast or to transfer the same data read out from the external memory 120 to the multiple NN operation cores 10. Additionally, the first DMAC 3 transfers data between the shared memory 8 and an external memory such as a DRAM.

The controller 6 is connected to the external bus EB and operates as a slave to an external host CPU 110. The controller 6 has a bus bridge 60 and a register 61.

The bus bridge 60 mediates bus access from the external bus EB to an internal bus IB. Additionally, the bus bridge 60 mediates write requests and read requests from the external host CPU 110 to the register 61.

The register 61 has a parameter register and a state register. The parameter register is a register for controlling the operation of the NN circuit 100. The state register is a register indicating the state of the NN circuit 100 and including pointers/instruction numbers or the like for command queues of respective modules. Additionally, the state register may be configured to include semaphores S. The external host CPU 110 can access the register 61 via the bus bridge 60 in the controller 6.

The controller 6 is connected, via the internal bus IB, to the respective blocks (the first DMAC 3, the IFU 7, the second DMAC 9 and the NN operation cores 10) of the NN circuit 100. The external host CPU 110 can access the respective blocks of the NN circuit 100 via the controller 6. For example, the external host CPU 110 can issue instructions to the NN operation cores 10 via the controller 6. Additionally, the respective blocks can update the state register (which may include the semaphores S) included in the controller 6 via the internal bus IB. The state register may be configured to be updated via dedicated wiring connected to the respective blocks.

The IFU (Instruction Fetch Unit) 7, based on instructions from the external host CPU 110, reads out, from the external memory 120, instruction commands to the respective blocks (the first DMAC 3, the second DMAC 9, the NN operation cores 10) of the NN circuit 100 via the external bus EB. Additionally, the IFU 7 transfers the instruction commands that have been read out to the respective corresponding blocks (the first DMAC 3, the second DMAC 9, the NN operation cores 10) of the NN circuit 100.

The shared memory 8 is a rewritable memory, such as a volatile memory composed of, for example, an SRAM (Static RAM). The shared memory 8 is a memory that temporarily records data being used by the NN operation cores 10, and that records data shared by the multiple NN operation cores.

The second DMAC 9 connects the shared memory 8 with the NN operation cores 10, and transfers data between the shared memory 8 and the NN operation cores 10. The second DMAC 9 may be capable of broadcasting data read out from the shared memory 8 to multiple NN operation cores 10.

The NN circuit 100 can use the second DMAC 9 to temporarily retain data and the like shared by the multiple NN operation cores in the shared memory 8, without using the first DMAC 3 to retain the data in the external memory 120, thereby allowing faster data transfer between the NN operation cores. The NN circuit 100 may not have the shared memory 8 and the second DMAC 9.

### [NN Operation Core 10]

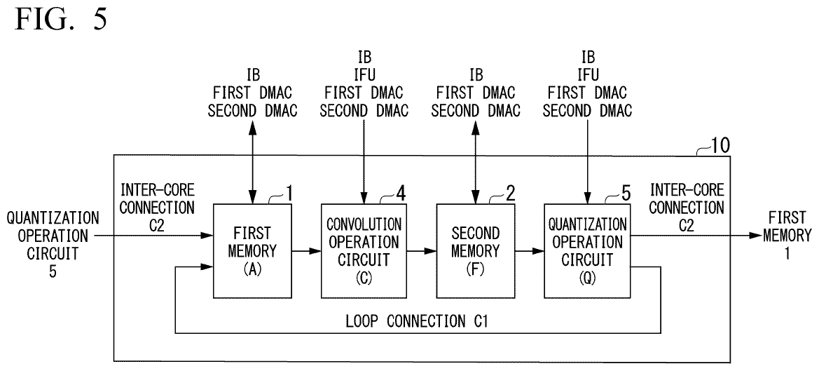

FIG. 5 is a diagram illustrating the overall structure of an NN operation core 10. The NN operation core 10 is provided with a first memory 1, a second memory 2, a convolution operation circuit 4 and a quantization operation circuit 5. The NN operation core 10 is characterized by having a convolution operation circuit 4 and a quantization operation circuit 5 forming a loop with a first memory 1 and a second memory 2 therebetween.

The first memory 1 is a rewritable memory, such as a volatile memory composed of, for example, an SRAM (Static RAM). Data is written into and read from the first memory 1 via the first DMAC 3, the second DMAC 9 and the internal bus IB. The external host CPU 110 can input and output data with respect to the NN operation cores 10 by writing in and reading out data with respect to the first memory 1.

The first memory 1 is connected to the input port of the convolution operation circuit 4, and the convolution operation circuit 4 can read data from the first memory 1. Additionally, the first memory 1 is loop-connected (C1) with the output port of the quantization operation circuit 5, and the quantization operation circuit 5 can write data into the first memory 1. Additionally, the first memory 1 can transfer data to other NN operation cores 10 by an inter-core connection (C2), and other NN operation cores 10 that are inter-core connected (C2) can write data into the first memory 1. In the present embodiment, a daisy-chain connection is used as an example of the inter-core connection (C2).

The second memory 2 is a rewritable memory, such as a volatile memory composed of, for example, an SRAM (Static RAM). Data is written into and read from the second memory 2 via the first DMAC 3, the second DMAC 9 and the internal bus IB. The external host CPU 110 can input and output data with respect to the NN operation cores 10 by writing in and reading out data with respect to the second memory 2.

The second memory 2 is connected to the input port of the quantization operation circuit 5, and the quantization operation circuit 5 can read data from the second memory 2. Additionally, the second memory 2 is connected with the output port of the convolution operation circuit 4, and the convolution operation circuit 4 can write data into the second memory 2.

The convolution operation circuit 4 is a circuit that performs a convolution operation in a convolution layer 210 in the trained CNN 200. The convolution operation circuit 4 reads input data a stored in the first memory 1 and implements a convolution operation on the input data a. The convolution operation circuit 4 writes output data f (hereinafter also referred to as “convolution operation output data”) from the convolution operation into the second memory 2.

The quantization operation circuit 5 is a circuit that performs at least part of a quantization operation in a quantization operation layer 220 in the trained CNN 200. The quantization operation circuit 5 reads the output data f from the convolution operation stored in the second memory 2, and performs a quantization operation (among pooling, batch normalization, an activation function, and quantization, the operation including at least quantization) on the output data f from the convolution operation.

The quantization operation circuit 5 writes the output data (hereinafter referred to as “quantization operation output data”) from the quantization operation into the loop-connected (C1) first memory 1. Additionally, the quantization operation circuit 5 can transfer data to the other NN operation cores 10 via the inter-core connection (C2), and the quantization operation circuit 5 can output quantization operation output data to the other inter-core connected (C2) NN operation cores 10.

Since the NN operation core 10 has a first memory 1, a second memory 2, etc., the number of data transfers of redundant data can be reduced in the data transfers from external memory such as a DRAM by the first DMAC 3. As a result thereof, the power consumption or processing load arising due to memory access can be largely reduced.

### Operational Example 1 of NN Operation Core 10

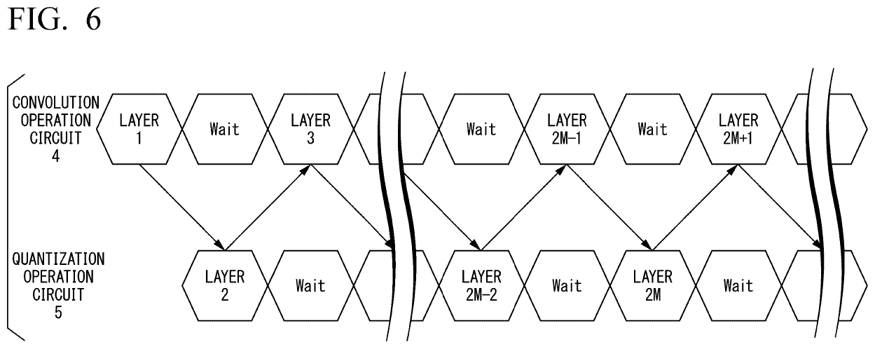

FIG. 6 is a timing chart indicating an operational example of the NN operation core 10.

The first DMAC 3 stores layer-1 input data a in a first memory 1. The first DMAC 3 may transfer the layer-1 input data a to the first memory 1 in a partitioned manner, in accordance with the sequence of convolution operations performed by the convolution operation circuit 4.

The convolution operation circuit 4 reads the layer-1 input data a stored in the first memory 1. The convolution operation circuit 4 performs the layer-1 convolution operation illustrated in FIG. 1 on the layer-1 input data a. The output data f from the layer-1 convolution operation is stored in the second memory 2.

The quantization operation circuit 5 reads the layer-1 output data f stored in the second memory 2. The quantization operation circuit 5 performs a layer-2 quantization operation on the layer-1 output data f The output data from the layer-2 quantization operation is stored in the first memory 1.

The convolution operation circuit 4 reads the layer-2 quantization operation output data stored in the first memory 1. The convolution operation circuit 4 performs a layer-3 convolution operation using the output data from the layer-2 quantization operation as the input data a. The output data f from the layer-3 convolution operation is stored in the second memory 2.

The convolution operation circuit 4 reads layer-(2M−2) (M being a natural number) quantization operation output data stored in the first memory 1. The convolution operation circuit 4 performs a layer-(2M−1) convolution operation with the output data from the layer-(2M−2) quantization operation as the input data a. The output data f from the layer-(2M−1) convolution operation is stored in the second memory 2.

The quantization operation circuit 5 reads the layer-(2M−1) output data f stored in the second memory 2. The quantization operation circuit 5 performs a layer-2M quantization operation on the layer-(2M−1) output data f The output data from the layer-2M quantization operation is stored in the first memory 1.

The convolution operation circuit 4 reads the layer-2M quantization operation output data stored in the first memory 1. The convolution operation circuit 4 performs a layer-(2M+1) convolution operation with the layer-2M quantization operation output data as the input data a. The output data f from the layer-(2M+1) convolution operation is stored in the second memory 2.

The convolution operation circuit 4 and the quantization operation circuit 5 perform operations in an alternating manner, thereby carrying out the operations of the CNN 200 indicated in FIG. 1. In the NN operation core 10, the convolution operation circuit 4 implements the layer-(2M−1) and layer-(2M+1) convolution operations in a time-divided manner. Additionally, in the NN operation core 10, the quantization operation circuit 5 implements the layer-(2M−2) and layer-2M quantization operations in a time-divided manner. Therefore, in the NN operation core 10, the circuit size is extremely small in comparison with the case in which a convolution operation circuit 4 and a quantization operation circuit 5 are mounted separately for each layer.

In the NN operation core 10, the operations of the CNN 200, which has a multilayered structure with multiple layers, are performed by circuits that form a loop. The NN operation core 10 can efficiently utilize hardware resources due to the looped circuit configuration. Since the NN operation core 10 has circuits forming a loop, the parameters in the convolution operation circuit 4 and the quantization operation circuit 5, which change in each layer, are appropriately updated.

If the operations in the CNN 200 include operations that cannot be implemented by the NN operation core 10, then the NN operation core 10 transfers intermediate data to an external operation device such as an external host CPU 110. After the external operation device has performed the operations on the intermediate data, the operation results from the external operation device are input to the first memory 1 and the second memory 2. The NN operation core 10 resumes operations on the operation results from the external operation device.

### Operational Example 2 of NN Operation Core 10

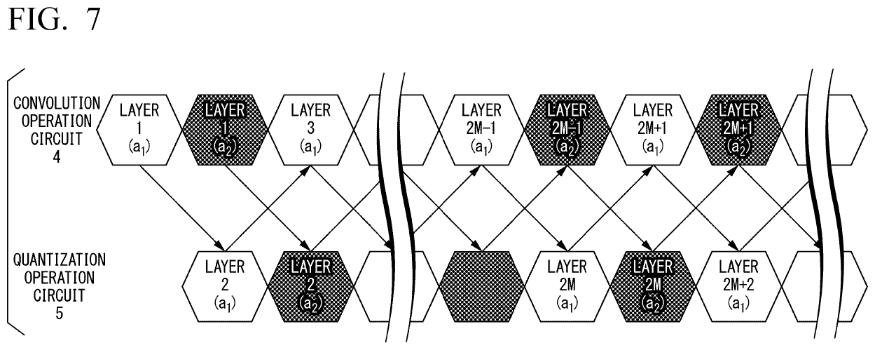

FIG. 7 is a timing chart illustrating another operational example of the NN operation core 10.

The NN operation core 10 may partition the input data a into partial tensors, and may perform operations on the partial tensors in a time-divided manner. The partitioning method and the number of partitions of the partial tensors are not particularly limited.

FIG. 7 shows an operational example for the case in which the input data a is decomposed into two partial tensors. The decomposed partial tensors are referred to as “first partial tensor a₁” and “second partial tensor a₂”. For example, the layer-(2M−1) convolution operation is decomposed into a convolution operation corresponding to the first partial tensor a₁ (in FIG. 7, indicated by “Layer 2M−1 (a₁)”) and a convolution operation corresponding to the second partial tensor a₂ (in FIG. 7, indicated by “Layer 2M−1 (a₂)”).

The convolution operations and the quantization operations corresponding to the first partial tensor a₁ can be implemented independently of the convolution operations and the quantization operations corresponding to the second partial tensor a₂, as illustrated in FIG. 7.

The convolution operation circuit 4 performs a layer-(2M−1) convolution operation corresponding to the first partial tensor a₁ (in FIG. 7, the operation indicated by layer 2M−1 (a₁)). Thereafter, the convolution operation circuit 4 performs a layer-(2M−1) convolution operation corresponding to the second partial tensor a₂ (in FIG. 7, the operation indicated by layer 2M−1 (a₂)). Additionally, the quantization operation circuit 5 performs a layer-2M quantization operation corresponding to the first partial tensor a₁ (in FIG. 7, the operation indicated by layer 2M (a₁)). Thus, the NN operation core 10 can implement the layer-(2M−1) convolution operation corresponding to the second partial tensor a₂ and the layer-2M quantization operation corresponding to the first partial tensor a₁ in parallel.

Next, the convolution operation circuit 4 performs a layer-(2M+1) convolution operation corresponding to the first partial tensor a₁ (in FIG. 7, the operation indicated by layer 2M+1 (a₁)). Additionally, the quantization operation circuit 5 performs a layer-2M quantization operation corresponding to the second partial tensor a₂ (in FIG. 7, the operation indicated by layer 2M (a₂)). Thus, the NN operation core 10 can implement the layer-(2M+1) convolution operation corresponding to the first partial tensor a₁ and the layer-2M quantization operation corresponding to the second partial tensor a₂ in parallel.

The convolution operations and the quantization operations corresponding to the first partial tensor a₁ can be implemented independently of the convolution operations and the quantization operations corresponding to the second partial tensor a₂. For this reason, the NN operation core 10 may, for example, implement the layer-(2M−1) convolution operation corresponding to the first partial tensor a₁ and the layer-(2M+2) quantization operation corresponding to the second partial tensor a₂ in parallel. In other words, the convolution operations and the quantization operations that are performed in parallel by the NN operation core 10 are not limited to being operations in consecutive layers.

By partitioning the input data a into partial tensors, the NN operation core 10 can make the convolution operation circuit 4 and the quantization operation circuit 5 operate in parallel. As a result thereof, the time during which the convolution operation circuit 4 and the quantization operation circuit 5 are idle can be reduced, thereby increasing the operation processing efficiency of the NN operation core 10. Although the number of partitions in the operational example indicated in FIG. 7 was two, the NN operation core 10 can similarly make the convolution operation circuit 4 and the quantization operation circuit 5 operate in parallel even in cases in which the number of partitions is greater than two.

For example, in the case in which the input data a is partitioned into a “first partial tensor a₁”, a “second partial tensor a₂” and a “third partial tensor a₃”, the NN operation core 10 can implement the layer-(2M−1) convolution operation corresponding to the second partial tensor a₂ and the layer-2M quantization operation corresponding to the third partial tensor a₃ in parallel. The sequence of operations can be appropriately changed in accordance with the storage status of the input data a in the first memory 1 and the second memory 2.

Regarding the operation method for the partial tensors, an example in which partial tensor operations in the same layer are performed by the convolution operation circuit 4 or the quantization operation circuit 5, then followed by partial tensor operations in the next layer (method 1) was described. For example, as indicated in FIG. 7, in the convolution operation circuit 4, after the layer-(2M−1) convolution operations corresponding to the first partial tensor a₁ and the second partial tensor a₂ (in FIG. 7, the operations indicated by layer 2M−1 (a₁) and layer 2M−1 (a₂)) are performed, the layer-(2M+1) convolution operations corresponding to the first partial tensor a₁ and the second partial tensor a₂ (in FIG. 7, the operations indicated by layer 2M+1 (a₁) and layer 2M+1 (a₂)) are implemented.

However, the operation method for the partial tensors is not limited thereto. The operation method for the partial tensors may be a method wherein operations on some of the partial tensors in multiple layers are followed by implementation of operations on the remaining partial tensors (method 2). For example, in the convolution operation circuit 4, after the convolution operations for layer (2M−1) corresponding to the first partial tensor a₁ and for layer (2M+1) corresponding to the first partial tensor a₁ have been performed, the convolution operations for layer (2M−1) corresponding to the second partial tensor a₂ and for layer (2M+1) corresponding to the second partial tensor a₂ may be performed.

Additionally, the operation method for the partial tensors may be a method that involves performing operations on the partial tensors by combining method 1 and method 2. However, in the case in which method 2 is used, the operations must be implemented in accordance with a dependence relationship relating to the operation sequence of the partial tensors.

### [NN Operation Multi-Core 10M]

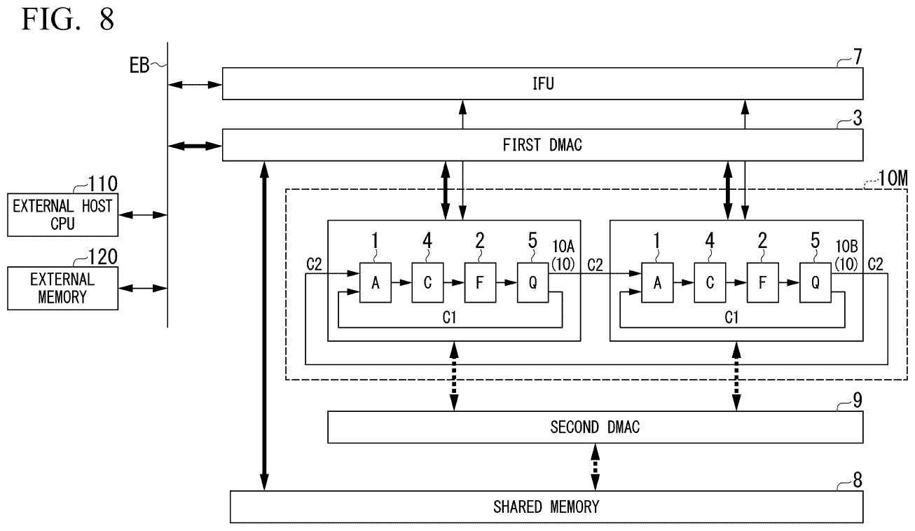

FIG. 8 is a diagram illustrating an NN operation multi-core 10M.

The NN operation multi-core 10M illustrated in FIG. 8 is provided with two NN operation cores 10 connected in a daisy chain. When distinguishing between the two NN operation cores 10, the two NN operation cores 10 will be referred to as the “first NN operation core 10A” and the “second NN operation core 10B”. In FIG. 8, the first memory 1 is abbreviated to “A”, the convolution operation circuit 4 is abbreviated to “C”, the second memory 2 is abbreviated to “F” and the quantization operation circuit 5 is abbreviated to “Q”.

Specifically, the quantization operation circuit 5 of the first NN operation core 10A and the first memory 1 of the second NN operation core 10B are daisy-chain connected (C2). The quantization operation circuit 5 of the first NN operation core 10A can write quantization operation output data to the loop-connected (C1) first memory 1 of the first NN operation core 10A or/and the daisy-chain connected (C2) first memory 1 of the second NN operation core 10B.

Specifically, the quantization operation circuit 5 of the second NN operation core 10B and the first memory 1 of the first NN operation core 10A are daisy-chain connected (C2). The quantization operation circuit 5 of the second NN operation core 10B can write quantization operation output data to the loop-connected (C1) first memory 1 of the second NN operation core 10B or/and the daisy-chain connected (C2) first memory 1 of the first NN operation core 10A.

In the case in which the NN operation multi-core 10M is provided with three or more NN operation cores 10, the multiple NN operation cores 10 are similarly connected in a daisy chain. The quantization operation circuits 5 of the NN operation cores 10 other than the final-stage NN operation core 10 are daisy-chain connected (C2) with the first memories 1 of the subsequent-stage NN operation cores 10B. The quantization operation circuit 5 of the final-stage NN operation core 10 is daisy-chain connected (C2) with the first memory 1 of the first-stage NN operation core 10. The multiple NN operation cores 10 are characterized by being formed in the form of a daisy-chain loop (as in a string of beads).

In one NN operation core 10, a first memory (A) 1, a convolution operation circuit (C) 4, a second memory (F) 2 and a quantization operation circuit (Q) 5 are connected in the form of a loop. Meanwhile, in the NN operation multi-core 10M, the first memories (A) 1, the convolution operation circuits (C) 4, the second memories (F) 2 and the quantization operation circuits (Q) 5 are connected in the form of a daisy-chain loop (as in a string of beads) so that the first memories (A) 1, the convolution operation circuits (C) 4, the second memories (F) 2 and the quantization operation circuits (Q) 5 are repeatedly arrayed in the same order.

The multiple NN operation cores 10 constituting the NN operation multi-core 10M may not have the same hardware structure. For example, the capacity and structure of the first memory 1 in the first NN operation core 10A may be different from the capacity and structure of the first memory 1 in the second NN operation core 10B. For example, the structure of the quantization operation circuit 5 in the first NN operation core 10A may be different from the structure of the quantization operation circuit 5 in the second NN operation core 10B.

### Operational Example 1 of NN Operation Multi-Core 10M

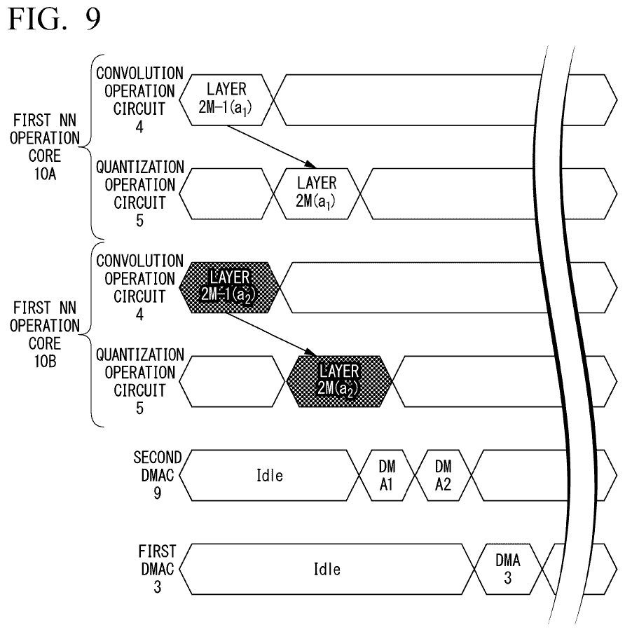

FIG. 9 is a timing chart indicating an operational example 1 of the NN operation multi-core 10M.

The convolution operations and the quantization operations corresponding to the first partial tensor a₁ and the convolution operations and the quantization operations corresponding to the second partial tensor a₂ are implemented independently by different NN operation cores 10, as illustrated in FIG. 9.

The convolution operation circuit 4 in the first NN operation core 10A performs a layer-(2M−1) convolution operation corresponding to the first partial tensor a₁ (in FIG. 9, the operation indicated by layer 2M−1 (a₁)). Thereafter, the quantization operation circuit 5 in the first NN operation core 10A performs a layer-2M quantization operation corresponding to the first partial tensor a₁ (in FIG. 9, the operation indicated by layer 2M (a₁)). The quantization operation circuit 5 in the first NN operation core 10A stores the layer-2M quantization operation output data corresponding to the first partial tensor a₁ in the first memory 1 in the first NN operation core 10A.

The convolution operation circuit 4 in the second NN operation core 10B performs a layer-(2M−1) convolution operation corresponding to the second partial tensor a₂ (in FIG. 9, the operation indicated by layer 2M−1 (a₂)). Thereafter, the quantization operation circuit 5 in the second NN operation core 10B performs a layer-2M quantization operation corresponding to the second partial tensor a₂ (in FIG. 9, the operation indicated by layer 2M (a₂)). The quantization operation circuit 5 in the second NN operation core 10B stores the layer-2M quantization operation output data corresponding to the second partial tensor a₂ in the first memory 1 in the second NN operation core 10B.

The second DMAC 9 DMA-transfers (in FIG. 9, the transfer indicated by DMA1), to the shared memory 8, the layer-2M quantization operation output data corresponding to the first partial tensor a₁ stored in the first memory 1 of the first NN operation core 10A. Next, the second DMAC 9 DMA-transfers (in FIG. 9, the transfer indicated by DMA2), to the shared memory 8, the layer-2M quantization operation output data corresponding to the second partial tensor a₂ stored in the first memory 1 of the second NN operation core 10B.

The first DMAC 3 DMA-transfers (in FIG. 9, the transfer indicated by DMA3), to the external memory 120, the layer-2M quantization operation output data corresponding to the first partial tensor a₁ and the second partial tensor a₂ stored in the shared memory 8.

The NN operation multi-core 10M can shorten the time necessary for operations, for example, by independently implementing the operations in the same layer by means of different NN operation cores 10. Additionally, the operation results of the respective NN operation cores 10 can be coordinated by the shared memory 8 and the second DMAC 9.

### Operational Example 2 of NN Operation Multi-Core 10M

FIG. 10 is a timing chart indicating an operational example 2 of the NN operation multi-core 10M.

The convolution operations and the quantization operations corresponding to the first partial tensor a₁ are implemented by cooperation between different NN operation cores 10.

The convolution operation circuit 4 in the first NN operation core 10A performs a layer-(2M−1) convolution operation corresponding to the first partial tensor a₁ (in FIG. 10, the operation indicated by layer 2M−1 (a₁)). Thereafter, the quantization operation circuit 5 in the first NN operation core 10A performs a layer-2M quantization operation corresponding to the first partial tensor a₁ (in FIG. 10, the operation indicated by layer 2M (a₁)). The quantization operation circuit 5 in the first NN operation core 10A stores the layer-2M quantization operation output data corresponding to the first partial tensor a₁ in the first memory 1 in the second NN operation core 10B.

The convolution operation circuit 4 in the second NN operation core 10B performs a layer-(2M+1) convolution operation corresponding to the first partial tensor a₁ (in FIG. 10, the operation indicated by layer 2M+1 (a₁)). Thereafter, the quantization operation circuit 5 in the second NN operation core 10B performs a layer-(2M+2) quantization operation corresponding to the first partial tensor a₁ (in FIG. 10, the operation indicated by layer 2M+2 (a₁)). The quantization operation circuit 5 in the second NN operation core 10B stores the layer-(2M+2) quantization operation output data corresponding to the second partial tensor a₂ in the first memory 1 in the second NN operation core 10B.

The first DMAC 3 DMA-transfers (in FIG. 10, the transfer indicated by DMA), to the external memory 120, the layer-(2M+2) quantization operation output data corresponding to the first partial tensor a₁ stored in the first memory 1 of the second NN operation core 10B.

The NN operation multi-core 10M can shorten the time necessary for operations, for example, by successively implementing operations corresponding to the same partial tensor by means of different NN operation cores 10.

### Operational Example 3 of NN Operation Multi-Core 10M

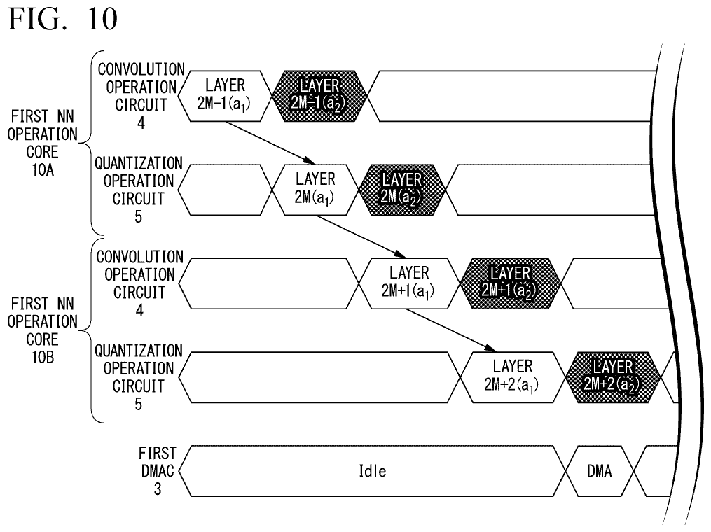

FIG. 11 is a timing chart indicating an operational example 3 of the NN operation multi-core 10M.

In operational example 3, the structure of the partial tensors is changed between the layer-(2M−1) convolution operation and the layer-(2M+1) convolution operation.

The second DMAC 9 DMA-transfers (in FIG. 11, the transfer indicated by DMA1) the first partial tensor a₁ to the first memory 1 in the first NN operation core 10A. Next, the second DMAC 9 DMA-transfers (in FIG. 11, the transfer indicated by DMA2) the second partial tensor a₂ to the first memory 1 in the second NN operation core 10B.

The convolution operation circuit 4 in the first NN operation core 10A performs a layer-(2M−1) convolution operation corresponding to the first partial tensor a₁ (in FIG. 11, the operation indicated by layer 2M−1 (a₁)). Thereafter, the quantization operation circuit 5 in the first NN operation core 10A performs a layer-2M quantization operation corresponding to the first partial tensor a₁ (in FIG. 11, the operation indicated by layer 2M (a₁)). The quantization operation circuit 5 in the first NN operation core 10A stores the layer-2M quantization operation output data corresponding to the first partial tensor a₁ in the first memory 1 in the first NN operation core 10A.

The second DMAC 9 DMA-transfers (in FIG. 11, the transfer indicated by DMA3), to the shared memory 8, the layer-2M quantization operation output data corresponding to the first partial tensor a₁ stored in the first memory 1 in the first NN operation core 10A.

The convolution operation circuit 4 in the second NN operation core 10B performs a layer-(2M−1) convolution operation corresponding to the second partial tensor a₂ (in FIG. 11, the operation indicated by layer 2M−1 (a₂)). The convolution operation by the convolution operation circuit 4 in the second NN operation core 10B starts later than the starting of the convolution operation by the convolution operation circuit 4 in the first NN operation core 10A. Thereafter, the quantization operation circuit 5 in the second NN operation core 10B performs a layer-2M quantization operation corresponding to the second partial tensor a₂ (in FIG. 11, the operation indicated by layer 2M (a₂)). The quantization operation circuit 5 in the second NN operation core 10B stores the layer-2M quantization operation output data corresponding to the second partial tensor a₂ in the first memory 1 in the second NN operation core 10B.

The second DMAC 9 DMA-transfers (in FIG. 11, the transfer indicated by DMA4), to the shared memory 8, the layer-2M quantization operation output data corresponding to the second partial tensor a₂ stored in the first memory 1 in the second NN operation core 10B.

For example, in the case in which the input data a in the layer-(2M−1) convolution operation has 32 channels in the c-axis direction and the input data a in layer-(2M+1) convolution operation has 64 channels in the c-axis direction, the partial tensor partitioning mode should preferably be changed in order to make efficient use of the convolution operation circuits 4, etc. in the layer-(2M+1) convolution operation. For example, suppose that the respective NN operation cores 10 are optimized to be able to perform parallel operations on input data a having 32 channels in the c-axis direction, and a layer-(2M+1) convolution operation is to be implemented on input data a having 64 channels in the c-axis direction. In this case, the mode of partitioning from the input data a to the partial tensors can be changed so that the convolution operation circuit 4 of the NN operation core 10A performs the operations on the input data a from channels 0 to 31, and the convolution operation circuit 4 of the NN operation core 10B performs the operations on the input data a from channels 32 to 63. Two of the re-partitioned partial tensors will be referred to as the “third partial tensor a₃” and the “fourth partial tensor a₄”.

The second DMAC 9 DMA-transfers (in FIG. 11, the transfer indicated by DMA5) the third partial tensor a₃ to the first memory 1 in the first NN operation core 10A. Next, the second DMAC 9 DMA-transfers (in FIG. 11, the transfer indicated by DMA6) the fourth partial tensor a₄ to the first memory 1 in the second NN operation core 10B.

The convolution operation circuit 4 in the first NN operation core 10A performs a layer-(2M+1) convolution operation corresponding to the third partial tensor a₃ (in FIG. 11, the operation indicated by layer 2M+1 (a₃)). Thereafter, the quantization operation circuit 5 in the first NN operation core 10A performs a layer-(2M+2) quantization operation corresponding to the third partial tensor a₃ (in FIG. 11, the operation indicated by layer 2M+2 (a₃)). The quantization operation circuit 5 in the first NN operation core 10A stores the layer-(2M+2) quantization operation output data corresponding to the third partial tensor a₃ in the first memory 1 in the first NN operation core 10A.

The convolution operation circuit 4 in the second NN operation core 10B performs a layer-(2M+1) convolution operation corresponding to the fourth partial tensor a₄ (in FIG. 11, the operation indicated by layer 2M+1 (a₄)). Thereafter, the quantization operation circuit 5 in the second NN operation core 10B performs a layer-(2M+2) quantization operation corresponding to the fourth partial tensor a₄ (in FIG. 11, the operation indicated by layer 2M+2 (a₄)). The quantization operation circuit 5 in the second NN operation core 10B stores the layer-(2M+2) quantization operation output data corresponding to the fourth partial tensor a₄ in the first memory 1 in the second NN operation core 10B.

Even in the case in which the characteristics of the input data a have changed (for example, the number of channels in the convolution operation increase, etc.), the NN circuit 100 can use the second DMAC 9 and the shared memory 8 to change the partitioning mode of the partial tensors assigned to the NN operation cores 10. The NN circuit 100 can reduce the number of times that input data a is to be retained, by DMA transfer, in the external memory 120 by using the first DMAC 3, even in the case in which the partial tensor partitioning mode is changed.

Next, the respective features of the NN circuit 100 will be explained in detail.

### [First DMAC 3]

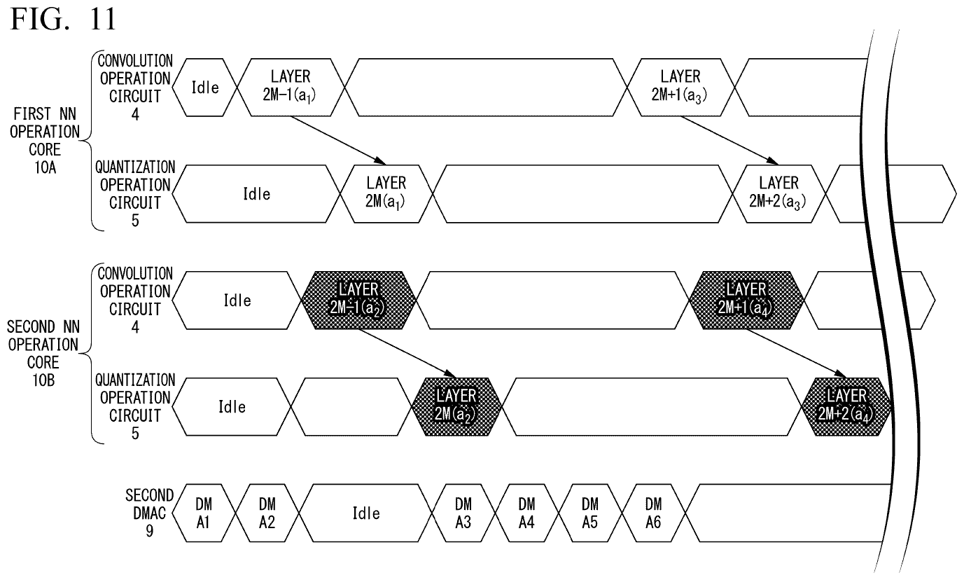

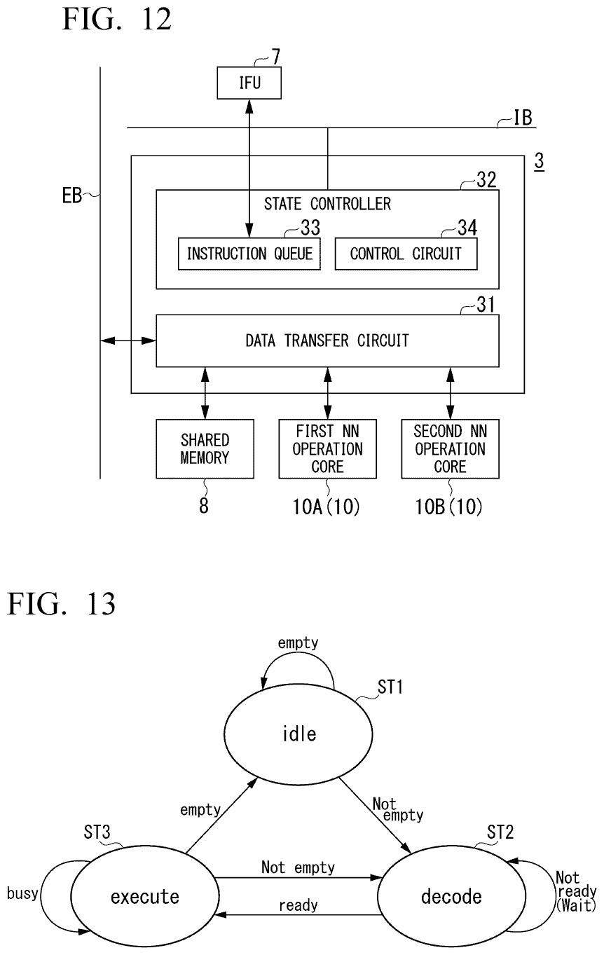

FIG. 12 is an internal block diagram of the first DMAC 3.

The first DMAC 3 has a data transfer circuit 31 and a state controller 32. The first DMAC 3 has a state controller 32 that is dedicated to the data transfer circuit 31, so that when an instruction command is input thereto, DMA data transfer can be implemented without requiring an external controller.

The data transfer circuit 31 is connected to the external bus EB and performs DMA data transfer between the external memory 120, such as a DRAM, and the NN operation cores 10. Additionally, the data transfer circuit 31 performs DMA data transfer between the external memory 120, such as a DRAM, and the shared memory 8. The number of DMA channels in the data transfer circuit 31 is not limited. For example, each of the first NN operation core 10A and the second NN operation core 10B may have a dedicated DMA channel.

The state controller 32 controls the state of the data transfer circuit 31. Additionally, the state controller 32 is connected to the controller 6 via the internal bus IB. The state controller 32 has an instruction queue 33 and a control circuit 34.

The instruction queue 33 is a queue in which instruction commands C3 for the first DMAC 3 are stored, and is constituted, for example, by an FIFO memory. One or more instruction commands C3 are written into the instruction queue 33 via the internal bus IB or the IFU 7.

The control circuit 34 is a state machine that decodes the instruction commands C3 and that sequentially controls the data transfer circuit 31 based on the instruction commands C3. The control circuit 34 may be implemented by a logic circuit, or may be implemented by a CPU controlled by software.

FIG. 13 is a state transition diagram of the control circuit 34.

The control circuit 34 transitions from an idle state ST1 to a decoding state ST2 when an instruction command C3 is input (Not empty) to the instruction queue 33.

In the decoding state ST2, the control circuit 34 decodes instruction commands C3 output from the instruction queue 33. Additionally, the control circuit 34 reads semaphores S stored in the register 61 in the controller 6, and determines whether or not the operation of the data transfer circuit 31 instructed by the instruction commands C3 can be executed. If an instruction command cannot be executed (Not ready), then the control circuit 34 waits until the instruction command can be executed (Wait). If the instruction command can be executed (ready), then the control circuit 34 transitions from the decoding state ST2 to an execution state ST3.

In the execution state ST3, the control circuit 34 controls the data transfer circuit 31 and makes the data transfer circuit 31 carry out the operations instructed by the instruction command C3. When the operations in the data transfer circuit 31 end, the control circuit 34 removes the instruction command C3 that has finished being executed from the instruction queue 33 and updates the semaphores S stored in the register 61 in the controller 6. If there is an instruction in the instruction queue 33 (Not empty), then the control circuit 34 transitions from the execution state ST3 to the decoding state ST2. If there are no instructions in the instruction queue 33 (empty), then the control circuit 34 transitions from the execution state ST3 to the idle state ST1.

### [Convolution Operation Circuit 4]

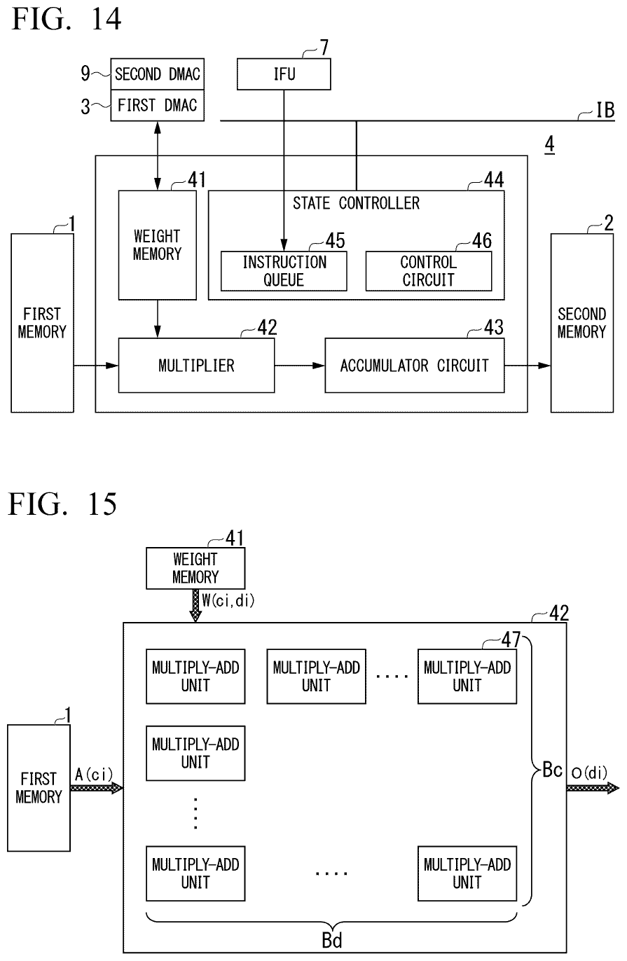

FIG. 14 is an internal block diagram of the convolution operation circuit 4.

The convolution operation circuit 4 has a weight memory 41, a multiplier 42, an accumulator circuit 43, and a state controller 44. The convolution operation circuit 4 has a state controller 44 that is dedicated to the multiplier 42 and the accumulator circuit 43, so that when an instruction command is input thereto, a convolution operation can be implemented without requiring an external controller.

The weight memory 41 is a memory for storing weights w used for convolution operations, and is, for example, a rewritable memory such as a volatile memory composed of an SRAM (Static Ram) or the like. The first DMAC 3 writes into the weight memory 41, by means of DMA transfer, the weights w necessary for convolution operations.

FIG. 15 is an internal block diagram of the multiplier 42.

The multiplier 42 multiplies an input vector A with a weight matrix W. The input vector A, as mentioned above, is vector data having Bc elements in which partitioned input data a(x+i, y+j, co) is expanded for each of i and j. Additionally, the weight matrix W is matrix data having Bc×Bd elements in which partitioned weights w(i, j, co, do) are expanded for each of i and j. The multiplier 42 has Bc×Bd multiply-add operation units 47, which can implement the multiplication of the input vector A and the weight matrix Win parallel.

The multiplier 42 reads out the input vector A and the weight matrix W that need to be multiplied from the first memory 1 and the weight memory 41, and implements the multiplication. The multiplier 42 outputs Bd multiply-add operation results O(di).

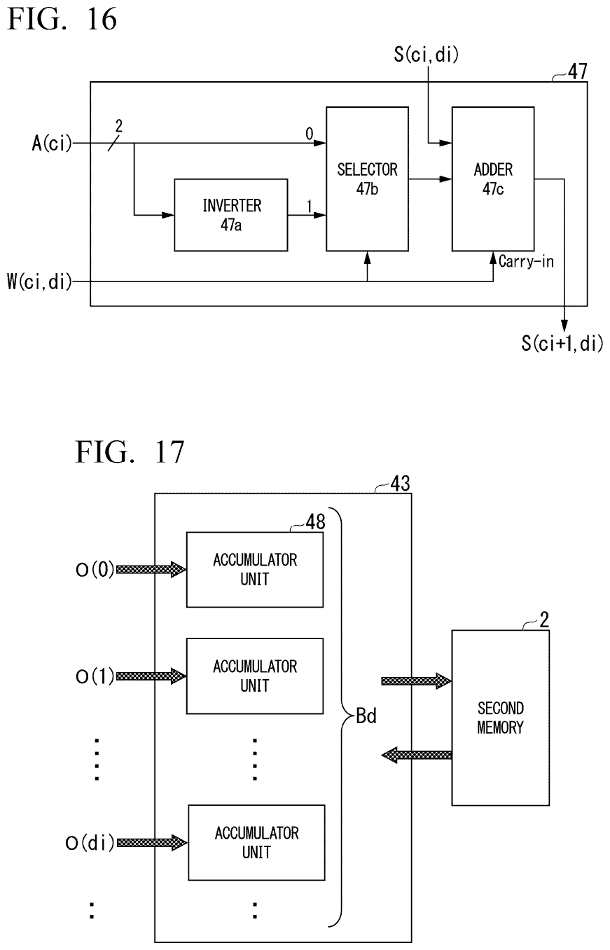

FIG. 16 is an internal block diagram of a multiply-add operation unit 47.

The multiply-add operation unit 47 implements multiplication of an element A(ci) of the input vector A with an element W(ci, di) of the weight matrix W. Additionally, the multiply-add operation unit 47 adds the multiplication results with the multiplication results S(ci, di) from other multiply-add operation units 47. The multiply-add operation unit 47 outputs the addition result S(ci+1, di). The elements A(ci) are 2-bit unsigned integers (0, 1, 2, 3). The elements W(ci, di) are 1-bit signed integers (0, 1), where the value “0” represents +1 and the value “1” represents −1.

The multiply-add operation unit 47 has an inverter 47a, a selector 47b, and an adder 47c. The multiply-add operation unit 47 performs multiplication using only the inverter 47a and the selector 47b, without using a multiplier. If the element W(ci, di) is “0”, then the selector 47b selects to input the element A(ci). If the element W(ci, di) is “1”, then the selector 47b selects a complement obtained by inverting the element A(ci) with the inverter. The element W(ci, di) is also input to the Carry-in of the adder 47c. If the element W(ci, di) is “0”, then the adder 47c outputs the value obtained by adding the element A(ci) to S(ci, di). If W(ci, di) is “1”, then the adder 47c outputs the value obtained by subtracting the element A(ci) from S(ci, di).

FIG. 17 is an internal block diagram of the accumulator circuit 43.

The accumulator circuit 43 accumulates, in the second memory 2, the multiply-add operation results O(di) from the multiplier 42. The accumulator circuit 43 has Bd accumulator units 48 and can accumulate Bd multiply-add operation results O(di) in the second memory 2 in parallel.

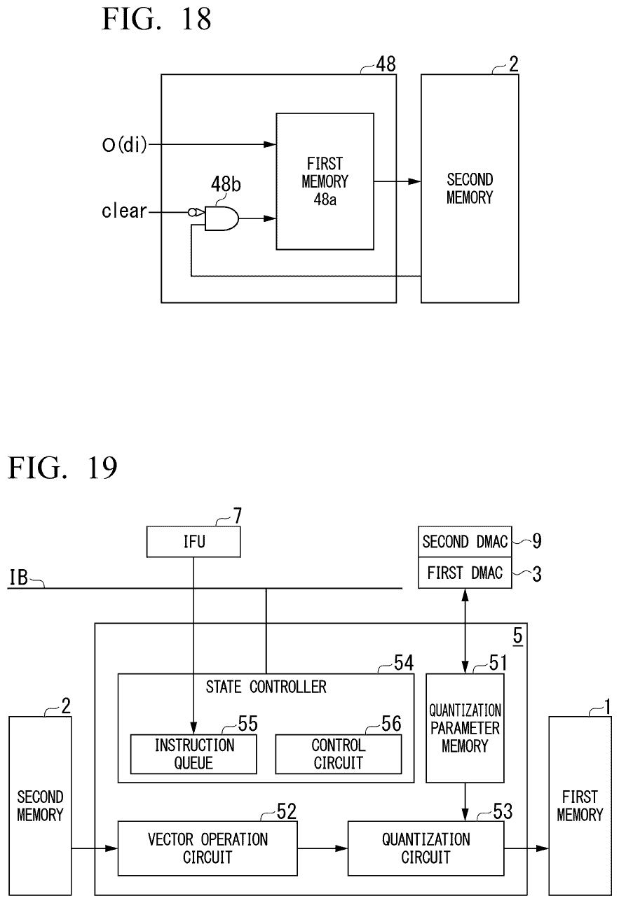

FIG. 18 is an internal block diagram of an accumulator unit 48.

The accumulator unit 48 has an adder 48a and a mask unit 48b. The adder 48a adds an element O(di) of the multiply-add operation results O to a partial sum that has been obtained midway through the convolution operation indicated by Equation 1 stored in the second memory 2. The addition results have 16 bits per element. The addition results are not limited to having 16 bits per element, and for example, may have 15 bits or 17 bits per element.

The adder 48a writes the addition results at the same address in the second memory 2. If an initialization signal “clear” is asserted, then the mask unit 48b masks the output from the second memory 2 and sets the value to be added to the element O(di) to zero. The initialization signal “clear” is asserted when a partial sum that has been obtained midway is not stored in the second memory 2.

When the convolution operation by the multiplier 42 and the accumulator circuit 43 is completed, output data f(x, y, do) is stored in the second memory.

The state controller 44 controls the states of the multiplier 42 and the accumulator circuit 43. Additionally, the state controller 44 is connected to the controller 6 via the internal bus IB. The state controller 44 has an instruction queue 45 and a control circuit 46.

The instruction queue 45 is a queue in which instruction commands C4 for the convolution operation circuit 4 are stored, and is constituted, for example, by an FIFO memory. Instruction commands C4 are written into the instruction queue 45 via the internal bus IB or the IFU 7.

The control circuit 46 is a state machine that decodes instruction commands C4 and that controls the multiplier 42 and the accumulator circuit 43 based on the instruction commands C4. The control circuit 46 has a structure similar to that of the control circuit 34 in the state controller 32 in the first DMAC 3.

### [Quantization Operation Circuit 5]

FIG. 19 is an internal block diagram of the quantization operation circuit 5. The quantization operation circuit 5 has a quantization parameter memory 51, a vector operation circuit 52, a quantization circuit 53, and a state controller 54. The quantization operation circuit 5 has a state controller 54 that is dedicated to the vector operation circuit 52 and the quantization circuit 53, so that when an instruction command is input thereto, a quantization operation can be implemented without requiring an external controller.

The quantization parameter memory 51 is a memory for storing quantization parameters q used for quantization operations, and is, for example, a rewritable memory such as a volatile memory composed of an SRAM (Static Ram) or the like. The first DMAC 3 writes into the quantization parameter memory 51, by means of DMA transfer, the quantization parameters q necessary for quantization operations.

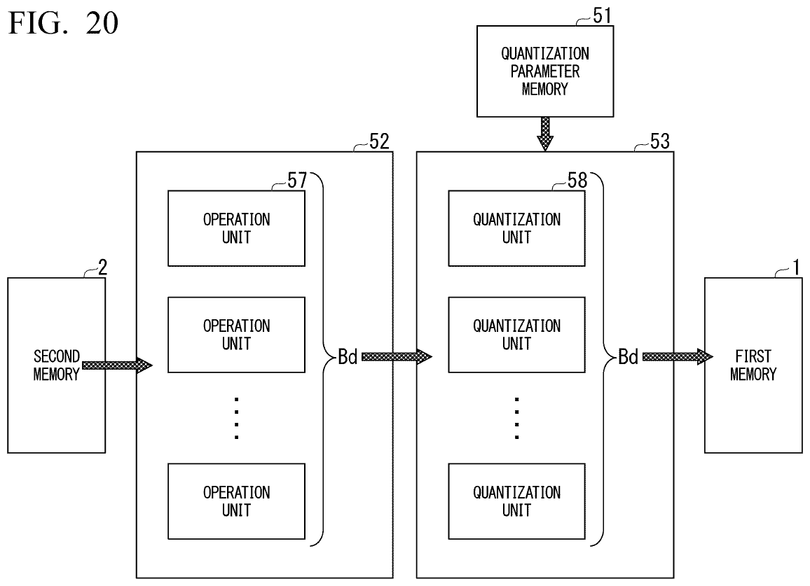

FIG. 20 is an internal block diagram of the vector operation circuit 52 and the quantization circuit 53.

The vector operation circuit 52 performs operations on output data f(x, y, do) stored in the second memory 2. The vector operation circuit 52 has Bd operation units 57, and performs SIMD operations on the output data f(x, y, do) in parallel.

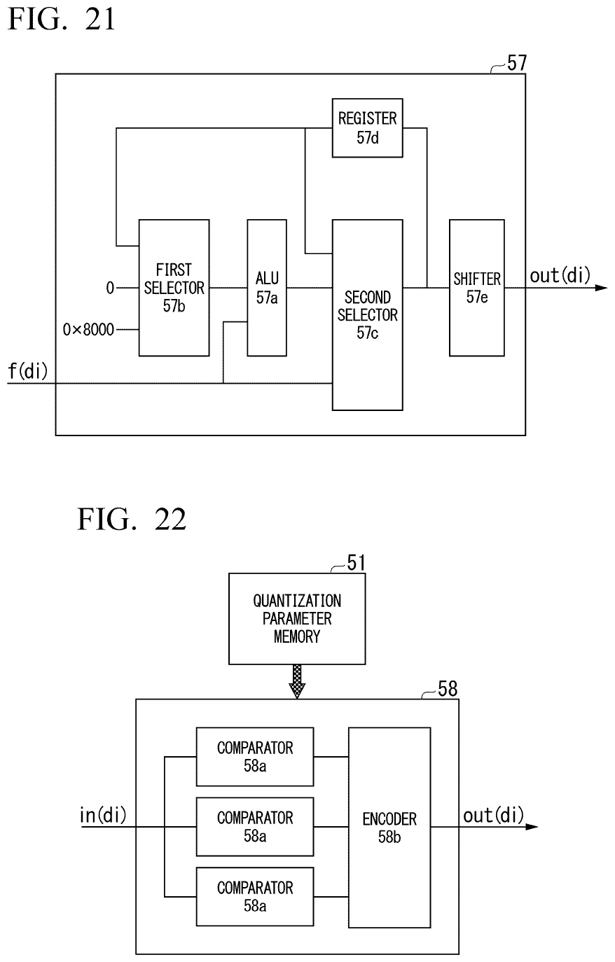

FIG. 21 is a block diagram of an operation unit 57.

The operation unit 57 has, for example, an ALU 57a, a first selector 57b, a second selector 57c, a register 57d, and a shifter 57e. The operation unit 57 may further have other operators or the like that are included in known general-purpose SIMD operation circuits.

The vector operation circuit 52 combines the operators and the like included in the operation units 57, thereby performing, on the output data f(x, y, do), the operations of at least one of the pooling layer 221, the batch normalization layer 222, or the activation function layer 223 in the quantization operation layer 220.

The operation unit 57 can use the ALU 57a to add the data stored in the register 57d to an element f(di) in the output data f(x, y, do) read from the second memory 2. The operation unit 57 can store the addition results from the ALU 57a in the register 57d. The operation unit 57 can initialize the addition results by using the first selector 57b to select a “0” as the value to be input to the ALU 57a instead of the data stored in the register 57d. For example, if the pooling region is 2×2, then the shifter 57e can output the average value of the addition results by shifting the output from the ALU 57a two bits to the right. The vector operation circuit 52 can implement the average pooling operation indicated by Equation 2 by having the Bd operation units 57 repeatedly perform the abovementioned operations and the like.

The operation unit 57 can use the ALU 57a to compare the data stored in the register 57d with an element f(di) in the output data f(x, y, do) read from the second memory 2. The operation unit 57 can control the second selector 57c in accordance with the comparison result from the ALU 57a, and can select the larger of the element f(di) and the data stored in the register 57d. The operation unit 57 can initialize the value to be compared so as to be the minimum value by using the first selector 57b to select the minimum value that the element f(di) may have as the value to be input to the ALU 57a. In the present embodiment, the element f(di) is a 16-bit signed integer, and thus, the minimum value that the element f(di) may have is “0x8000”. The vector operation circuit 52 can implement the max pooling operation in Equation 3 by having the Bd operation units 57 repeatedly perform the abovementioned operations and the like. In the max pooling operation, the shifter 57e does not shift the output of the second selector 57c.

The operation unit 57 can use the ALU 57a to perform subtraction between the data stored in the register 57d and an element f(di) in the output data f(x, y, do) read from the second memory 2. The shifter 57e can shift the output of the ALU 57a to the left (i.e., multiplication) or to the right (i.e., division). The vector operation circuit 52 can implement the batch normalization operation in Equation 4 by having the Bd operation units 57 repeatedly perform the abovementioned operations and the like.

The operation unit 57 can use the ALU 57a to compare an element f(di) in the output data f(x, y, do) read from the second memory 2 with “0” selected by the first selector 57b. The operation unit 57 can, in accordance with the comparison result in the ALU 57a, select and output either the element f(di) or the constant value “0” prestored in the register 57d. The vector operation circuit 52 can implement the ReLU operation in Equation 5 by having the Bd operation units 57 repeatedly perform the abovementioned operations and the like.

The vector operation circuit 52 can implement average pooling, max pooling, batch normalization, and activation function operations, as well as combinations of these operations. The vector operation circuit 52 can implement general-purpose SIMD operations, and thus may implement other operations necessary for operations in the quantization operation layer 220. Additionally, the vector operation circuit 52 may implement operations other than operations in the quantization operation layer 220.

The quantization operation circuit 5 need not have a vector operation circuit 52. If the quantization operation circuit 5 does not have a vector operation circuit 52, then the output data f(x, y, do) is input to the quantization circuit 53.

The quantization circuit 53 performs quantization of the output data from the vector operation circuit 52. The quantization circuit 53, as illustrated in FIG. 20, has Bd quantization units 58, and performs operations on the output data from the vector operation circuit 52 in parallel.

FIG. 22 is an internal block diagram of a quantization unit 58.

The quantization unit 58 performs quantization of an element in(di) in the output data from the vector operation circuit 52. The quantization unit 58 has a comparator 58a and an encoder 58b. The quantization unit 58 performs, on output data (16 bits/element) from the vector operation circuit 52, an operation (Equation 6) of the quantization layer 224 in the quantization operation layer 220. The quantization unit 58 reads the necessary quantization parameters q(th0, th1, th2) from the quantization parameter memory 51 and uses the comparator 58a to compare the input in(di) with the quantization parameter q. The quantization unit 58 uses the encoder 58b to quantize the comparison results from the comparator 58a to 2 bits/element. In Equation 4, α(c) and β(c) are parameters that are different for each variable c. Thus, the quantization parameters q(th0, th1, th2), which reflect α(c) and β(c), are parameters that are different for each value of in(di).

The quantization unit 58 classifies the input in(di) into four regions (for example, in≤th0, th0<in≤th1, th1<in≤th2, th2<in) by comparing the input in(di) with the three threshold values th0, th1 and th2. The classification results are encoded in 2 bits and output. The quantization unit 58 can also perform batch normalization and activation function operations together with quantization by setting the quantization parameters q(th0, th1, th2).

The quantization unit 58 can implement the batch normalization operation indicated in Equation 4 together with quantization by performing quantization with the threshold value th0 set to β(c) in Equation 4 and with the differences (th1−th0) and (th2−th1) between the threshold values set as α(c) in Equation 4. The value of α(c) can be made smaller by making (th1−th0) and (th2−th1) larger. The value of α(c) can be made larger by making (th1−th0) and (th2−th1) smaller.

The quantization unit 58 can implement an activation function together with quantization of the input in(di). For example, the output value of the quantization unit 58 is saturated in the regions where in(di)≤th0 and th2<in(di). The quantization unit 58 can implement the activation function operation together with quantization by setting the quantization parameter q so that the output becomes nonlinear.

The state controller 54 controls the states of the vector operation circuit 52 and the quantization circuit 53. Additionally, the state controller 54 is connected to the controller 6 via the internal bus IB. The state controller 54 has an instruction queue 55 and a control circuit 56.

The instruction queue 55 is a queue in which instruction commands C5 for the quantization operation circuit 5 are stored, and is constituted, for example, by an FIFO memory. Instruction commands C5 are written into the instruction queue 55 via the internal bus IB or the IFU 7.

The control circuit 56 is a state machine that decodes instruction commands C5 and that controls the vector operation circuit 52 and the quantization circuit 53 based on the instruction commands C5. The control circuit 56 has a structure similar to the control circuit 34 of the state controller 32 in the first DMAC 3.

The quantization operation circuit 5 writes quantization operation output data having Bd elements into the first memory 1. A suitable relationship between Bd and Bc is indicated by Equation 10. In Equation 10, n is an integer.

$$Bd = {2}^{n} \cdot Bc \qquad [ Equation 10 ]$$

### [Controller 6]

The controller 6 transfers instruction commands that have been transferred from the external host CPU 110, via the internal bus IB, to instruction queues included in the first DMAC 3, the second DMAC 9, the convolution operation circuit 4, and the quantization operation circuit 5. The controller 6 may have an instruction memory in which instruction commands for the respective circuits are stored.

The controller 6 is connected to the external bus EB and operates as a slave to the external host CPU 110. The controller 6 has a register 61 including a parameter register and a state register. The parameter register is a register for controlling the operation of the NN circuit 100. The state register is a register indicating the state of the NN circuit 100 and including semaphores S.

### [Semaphores S]

The semaphores S are decremented by P operations and incremented by V operations. P operations and V operations by the first DMAC 3, the convolution operation circuit 4, and the quantization operation circuit 5 update the semaphores S included in the controller 6 via the internal bus IB.

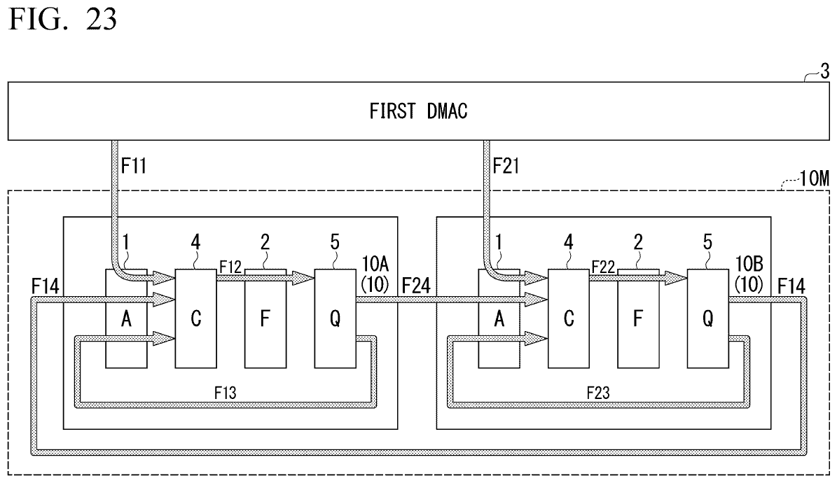

FIG. 23 is a diagram for explaining control of the NN circuit 100 by semaphores S.

The semaphores S are provided for each data flow F mediated by the memories (first memory 1, second memory 2) in the NN circuit 100. In FIG. 23 and the following explanation, the semaphores relating to data flow associated with the second DMAC 9 are omitted in order to simplify the explanation. Since the NN circuit 100 in the present embodiment includes multiple NN operation cores 10, there are multiple data flows. Which data flow is to be used to execute the operations relating to the CNN 200 is controlled by the corresponding instruction command.

### [Semaphores S Relating to First NN Operation Core 10A]

The semaphores S, with regard to the first NN operation core 10A, include first semaphores S11, second semaphores S12, third semaphores S13, and fourth semaphores S14.

The first semaphores S11 are used to control a first data flow F11 in the first NN operation core 10A. The first data flow F11 is a data flow by which the first DMAC 3 (Producer) writes input data a into the first memory 1 in the first NN operation core 10A and the convolution operation circuit 4 (Consumer) in the first NN operation core 10A reads the input data a. The first semaphores S11 include a first write semaphore S11W and a first read semaphore S11R.

The second semaphores S12 are used to control a second data flow F12 in the first NN operation core 10A. The second data flow F12 is a data flow by which the convolution operation circuit 4 (Producer) in the first NN operation core 10A writes output data f into the second memory 2 in the first NN operation core 10A and the quantization operation circuit 5 (Consumer) in the first NN operation core 10A reads the output data f. The second semaphores S12 include a second write semaphore S12W and a second read semaphore S12R.

The third semaphores S13 are used to control a third data flow F13 in the first NN operation core 10A. The third data flow F13 is a data flow by which the quantization operation circuit 5 (Producer) in the first NN operation core 10A writes quantization operation output data into the first memory 1 in the first NN operation core 10A and the convolution operation circuit 4 (Consumer) in the first NN operation core 10A reads the quantization operation output data. The third semaphores S13 include a third write semaphore S13W and a third read semaphore S13R.

The fourth semaphores S14 are used to control a fourth data flow F14 in the first NN operation core 10A. The fourth data flow F14 is a data flow by which the quantization operation circuit 5 (Producer) in the second NN operation core 10B writes quantization operation output data into the first memory 1 in the first NN operation core 10A and the convolution operation circuit 4 (Consumer) in the first NN operation core 10A reads the quantization operation output data. The fourth semaphores S14 include a fourth write semaphore S14W and a fourth read semaphore S14R.

### [Semaphores S Relating to Second NN Operation Core 10B]

The semaphores S, with regard to the second NN operation core 10B, include first semaphores S21, second semaphores S22, third semaphores S23, and fourth semaphores S24.

The first semaphores S21 are used to control a first data flow F21 in the second NN operation core 10B. The first data flow F21 is a data flow by which the first DMAC 3 (Producer) writes input data a into the first memory 1 in the second NN operation core 10B and the convolution operation circuit 4 (Consumer) in the second NN operation core 10B reads the input data a. The first semaphores S21 include a first write semaphore S21W and a first read semaphore S21R.

The second semaphores S22 are used to control a second data flow F22 in the second NN operation core 10B. The second data flow F22 is a data flow by which the convolution operation circuit 4 (Producer) in the second NN operation core 10B writes output data f into the second memory 2 in the second NN operation core 10B and the quantization operation circuit 5 (Consumer) in the second NN operation core 10B reads the output data f The second semaphores S22 include a second write semaphore S22W and a second read semaphore S22R.

The third semaphores S23 are used to control a third data flow F23 in the second NN operation core 10B. The third data flow F23 is a data flow by which the quantization operation circuit 5 (Producer) in the second NN operation core 10B writes quantization operation output data into the first memory 1 in the second NN operation core 10B and the convolution operation circuit 4 (Consumer) in the second NN operation core 10B reads the quantization operation output data. The third semaphores S23 include a third write semaphore S23W and a third read semaphore S23R.

The fourth semaphores S24 are used to control a fourth data flow F24 in the second NN operation core 10B. The fourth data flow F24 is a data flow by which the quantization operation circuit 5 (Producer) in the first NN operation core 10A writes quantization operation output data into the first memory 1 in the second NN operation core 10B and the convolution operation circuit 4 (Consumer) in the second NN operation core 10B reads the quantization operation output data. The fourth semaphores S24 include a fourth write semaphore S24W and a fourth read semaphore S24R.

### [First Data Flow F11 in First NN Operation Core 10A]

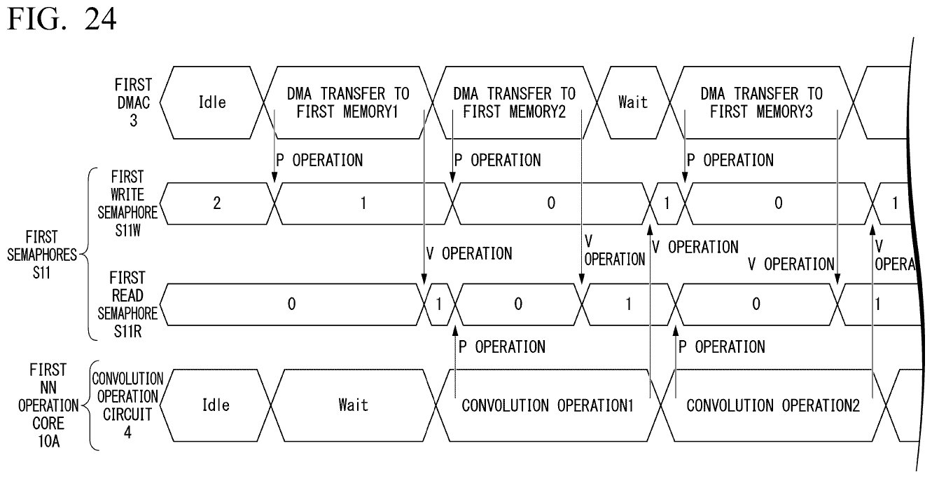

FIG. 24 is a timing chart of the first data flow F11.

The first write semaphore S11W is a semaphore that restricts writing into the first memory 1 in the first NN operation core 10A by the first DMAC 3 in the first data flow F11 in the first NN operation core 10A. The first write semaphore S11W indicates, for example, among the memory areas in the first memory 1 in which data of a prescribed size, such as that of an input vector A, can be stored, the number of memory areas from which data has been read and into which other data can be written. If the first write semaphore S11W is “0”, then the first DMAC 3 cannot perform the writing in the first data flow F11 with respect to the first memory 1, and must wait until the first write semaphore S11W becomes at least “1”.

The first read semaphore S11R is a semaphore that restricts reading from the first memory 1 in the first NN operation core 10A by the convolution operation circuit 4 in the first NN operation core 10A in the first data flow F11 in the first NN operation core 10A. The first read semaphore S11R indicates, for example, among the memory areas in the first memory 1 in which data of a prescribed size, such as that of an input vector A, can be stored, the number of memory areas into which data has been written and can be read. If the first read semaphore S11R is “0”, then the convolution operation circuit 4 cannot perform the reading in the first data flow F11 with respect to the first memory 1, and must wait until the first read semaphore S11R becomes at least “1”.

The first DMAC 3 initiates DMA transfer when an instruction command C3 is stored in the instruction queue 33. As indicated in FIG. 24, the first write semaphore S11W is not “0”. Thus, the first DMAC 3 initiates DMA transfer (DMA transfer 1). The first DMAC 3 performs a P operation on the first write semaphore S11W when initiating a DMA transfer. The first DMAC 3 performs a V operation on the first read semaphore S11R after the DMA transfer is completed.

The convolution operation circuit 4 in the first NN operation core 10A initiates a convolution operation when an instruction command C4 is stored in the instruction queue 45. As indicated in FIG. 24, the first read semaphore S11R is “0”. Thus, the convolution operation circuit 4 must wait until the first read semaphore S11R becomes at least “1” (“Wait” in the decoding state ST2). When the first read semaphore S11R becomes “1” due to a V operation by the first DMAC 3, the convolution operation circuit 4 initiates a convolution operation (convolution operation 1). When initiating the convolution operation, the convolution operation circuit 4 performs a P operation with respect to the first read semaphore S11R. After completing the convolution operation, the convolution operation circuit 4 performs a V operation on the first write semaphore S11W.

When the first DMAC 3 initiates the DMA transfer denoted by “DMA transfer 3” in FIG. 24, the first write semaphore S11W is “0”. Thus, the first DMAC 3 must wait until the first write semaphore S11W becomes at least “1” (“Wait” in the decoding state ST2). When the first write semaphore S11W becomes at least “1” due to a V operation by the convolution operation circuit 4, the first DMAC 3 initiates a DMA transfer.

By using the first semaphores S11, the first DMAC 3 and the convolution operation circuit 4 in the first NN operation core 10A can prevent competition for access to the first memory 1 in the first data flow F11. Additionally, by using the first semaphores S11, the first DMAC 3 and the convolution operation circuit 4 in the first NN operation core 10A can operate independently and in parallel while synchronizing data transfer in the first data flow F11 in the first NN operation core 10A.

### [Second Data Flow F12 in First NN Operation Core 10A]

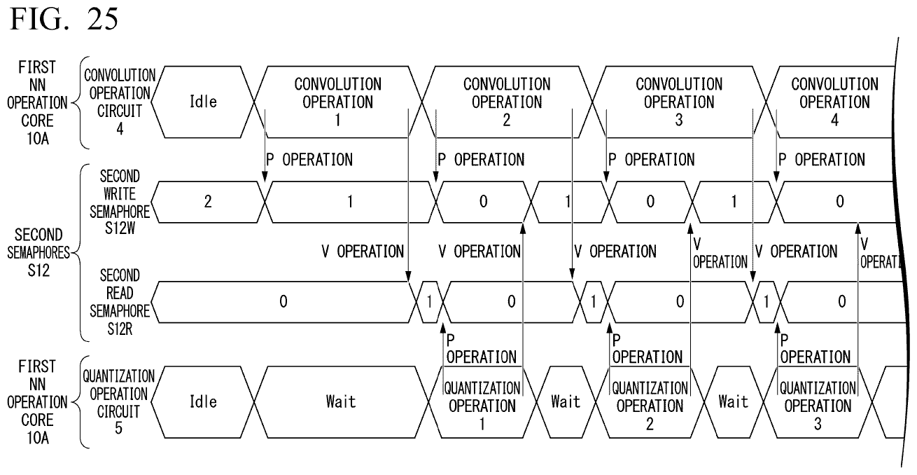

FIG. 25 is a timing chart of the second data flow F12.

The second write semaphore S12W is a semaphore that restricts writing into the second memory 2 in the first NN operation core 10A by the convolution operation circuit 4 in the first NN operation core 10A in the second data flow F12 in the first NN operation core 10A. The second write semaphore S12W indicates, for example, among the memory areas in the second memory 2 in which data of a prescribed size, such as that of output data f, can be stored, the number of memory areas from which data has been read and into which other data can be written. If the second write semaphore S12W is “0”, then the convolution operation circuit 4 cannot perform the writing in the second data flow F12 with respect to the second memory 2, and must wait until the second write semaphore S12W becomes at least “1”.

The second read semaphore S12R is a semaphore that restricts reading from the second memory 2 in the first NN operation core 10A by the quantization operation circuit 5 in the first NN operation core 10A in the second data flow F2 in the first NN operation core 10A. The second read semaphore S12R indicates, for example, among the memory areas in the second memory 2 in which data of a prescribed size, such as that of output data f, can be stored, the number of memory areas into which data has been written and can be read. If the second read semaphore S12R is “0”, then the quantization operation circuit 5 cannot perform the reading in the second data flow F12 with respect to the second memory 2, and must wait until the second read semaphore S12R becomes at least “1”.

As indicated in FIG. 25, the convolution operation circuit 4 in the first NN operation core 10A performs a P operation on the second write semaphore S12W when initiating a convolution operation. The convolution operation circuit 4 performs a V operation on the second read semaphore S12R after the convolution operation is completed.

The quantization operation circuit 5 in the first NN operation core 10A initiates a quantization operation when an instruction command C5 is stored in the instruction queue 55. As indicated in FIG. 25, the second read semaphore S12R is “0”. Thus, the quantization operation circuit 5 must wait until the second read semaphore S12R becomes at least “1” (“Wait” in the decoding state ST2). When the second read semaphore S12R becomes “1” due to a V operation by the convolution operation circuit 4, the quantization operation circuit 5 initiates a quantization operation (quantization operation 1). When initiating the quantization operation, the quantization operation circuit 5 performs a P operation with respect to the second read semaphore S12R. After completing the quantization operation, the quantization operation circuit 5 performs a V operation on the second write semaphore S12W.

When the quantization operation circuit 5 initiates the quantization operation denoted by “quantization operation 2” in FIG. 25, the second read semaphore S12R is “0”. Thus, the quantization operation circuit 5 must wait until the second read semaphore S12R becomes at least “1” (“Wait” in the decoding state ST2). When the second read semaphore S12R becomes at least “1” due to a V operation by the convolution operation circuit 4, the quantization operation circuit 5 initiates a quantization operation.

By using the second semaphores S12, the convolution operation circuit 4 in the first NN operation core 10A and the quantization operation circuit 5 in the first NN operation core 10A can prevent competition for access to the second memory 2 in the second data flow F12. Additionally, by using the second semaphores S12, the convolution operation circuit 4 in the first NN operation core 10A and the quantization operation circuit 5 in the first NN operation core 10A can operate independently and in parallel while synchronizing data transfer in the second data flow F12.

### [Third Data Flow F13 in First NN Operation Core 10A]

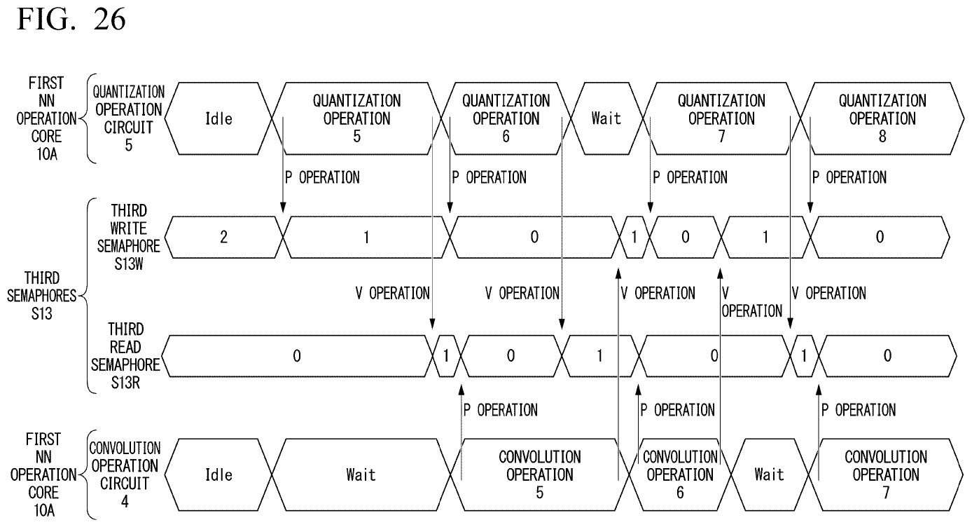

FIG. 26 is a timing chart of the third data flow F13.

The third write semaphore S13W is a semaphore that restricts writing into the first memory 1 in the first NN operation core 10A by the quantization operation circuit 5 in the first NN operation core 10A in the third data flow F13 in the first NN operation core 10A. The third write semaphore S13W indicates, for example, among the memory areas in the first memory 1 in which data of a prescribed size, such as that of the quantization operation output data of the quantization operation circuit 5, can be stored, the number of memory areas from which data has been read and into which other data can be written. If the third write semaphore S13W is “0”, then the quantization operation circuit 5 cannot perform the writing in the third data flow F13 with respect to the first memory 1, and must wait until the third write semaphore S13W becomes at least “1”.

The third read semaphore S13R is a semaphore that restricts reading from the first memory 1 in the first NN operation core 10A by the convolution operation circuit 4 in the first NN operation core 10A in the third data flow F13 in the first NN operation core 10A. The third read semaphore S13R indicates, for example, among the memory areas in the first memory 1 in which data of a prescribed size, such as that of the quantization operation output data of the quantization operation circuit 5, can be stored, the number of memory areas into which data has been written and can be read. If the third read semaphore S13R is “0”, then the convolution operation circuit 4 cannot perform the reading in the third data flow F13 with respect to the first memory 1, and must wait until the third read semaphore S13R becomes at least “1”.

As indicated in FIG. 26, the quantization operation circuit 5 in the first NN operation core 10A performs a P operation on the third write semaphore S13W when initiating a quantization operation. The quantization operation circuit 5 performs a V operation on the third read semaphore S13R after the convolution operation is completed.

The convolution operation circuit 4 in the first NN operation core 10A initiates a convolution operation when an instruction command C4 is stored in the instruction queue 45. As indicated in FIG. 26, the third read semaphore S13 is “0”. Thus, the convolution operation circuit 4 must wait until the third read semaphore S13R becomes at least “1” (“Wait” in the decoding state ST2). When the third read semaphore S13R becomes “1” due to a V operation by the quantization operation circuit 5, the convolution operation circuit 4 initiates a convolution operation (convolution operation 5). When initiating the convolution operation, the convolution operation circuit 4 performs a P operation with respect to the third read semaphore S13R. After completing the convolution operation, the convolution operation circuit 4 performs a V operation on the third write semaphore S13W.

When the convolution operation circuit 4 initiates the convolution operation denoted by “convolution operation 7” in FIG. 26, the third read semaphore S13R is “0”. Thus, the convolution operation circuit 4 must wait until the third read semaphore S13R becomes at least “1” (“Wait” in the decoding state ST2). When the third read semaphore S13R becomes at least “1” due to a V operation by the quantization operation circuit 5, the convolution operation circuit 4 initiates a convolution operation.

By using the third semaphores S13, the quantization operation circuit 5 in the first NN operation core 10A and the convolution operation circuit 4 in the first NN operation core 10A can prevent competition for access to the first memory 1 in the third data flow F13. Additionally, by using the third semaphores S13, the quantization operation circuit 5 in the first NN operation core 10A and the convolution operation circuit 4 in the first NN operation core 10A can operate independently and in parallel while synchronizing data transfer in the third data flow F13.

### [Fourth Data Flow F14 in First NN Operation Core 10A]

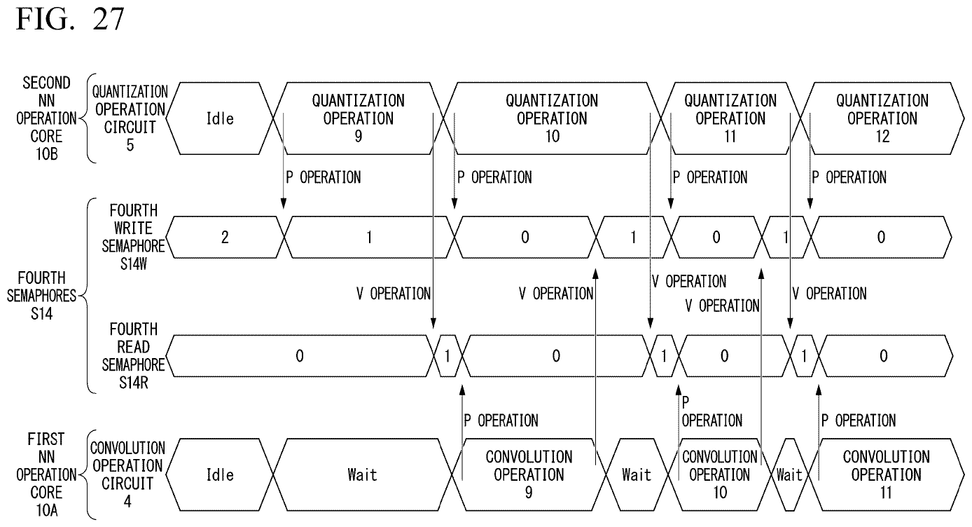

FIG. 27 is a timing chart of the fourth data flow F14.

The fourth write semaphore S14W is a semaphore that restricts writing into the first memory 1 in the first NN operation core 10A by the quantization operation circuit 5 in the second NN operation core 10B in the fourth data flow F14 in the first NN operation core 10A. The fourth write semaphore S14W indicates, for example, among the memory areas in the first memory 1 in which data of a prescribed size, such as that of the quantization operation output data of the quantization operation circuit 5, can be stored, the number of memory areas from which data has been read and into which other data can be written. If the fourth write semaphore S14W is “0”, then the quantization operation circuit 5 cannot perform the writing in the fourth data flow F14 with respect to the first memory 1, and must wait until the fourth write semaphore S14W becomes at least “1”.

The fourth read semaphore S14R is a semaphore that restricts reading from the first memory 1 in the first NN operation core 10A by the convolution operation circuit 4 in the first NN operation core 10A in the fourth data flow F14 in the first NN operation core 10A. The fourth read semaphore S14R indicates, for example, among the memory areas in the first memory 1 in which data of a prescribed size, such as that of the quantization operation output data of the quantization operation circuit 5, can be stored, the number of memory areas into which data has been written and can be read. If the fourth read semaphore S14R is “0”, then the convolution operation circuit 4 cannot perform the reading in the fourth data flow F14 with respect to the first memory 1, and must wait until the fourth read semaphore S14R becomes at least “1”.

As indicated in FIG. 27, the quantization operation circuit 5 in the second NN operation core 10B performs a P operation on the fourth write semaphore S14W when initiating a quantization operation. The quantization operation circuit 5 performs a V operation on the fourth read semaphore S14R after the convolution operation is completed.

The convolution operation circuit 4 in the first NN operation core 10A initiates a convolution operation when an instruction command C4 is stored in the instruction queue 45. As indicated in FIG. 27, the fourth read semaphore S14R is “0”. Thus, the convolution operation circuit 4 must wait until the fourth read semaphore S14R becomes at least “1” (“Wait” in the decoding state ST2). When the fourth read semaphore S14R becomes “1” due to a V operation by the quantization operation circuit 5, the convolution operation circuit 4 initiates a convolution operation (convolution operation 9). When initiating the convolution operation, the convolution operation circuit 4 performs a P operation with respect to the fourth read semaphore S14R. After completing the convolution operation, the convolution operation circuit 4 performs a V operation on the fourth write semaphore S14W.

When the convolution operation circuit 4 initiates the convolution operation denoted by “convolution operation 10” in FIG. 27, the fourth read semaphore S14R is “0”. Thus, the convolution operation circuit 4 must wait until the fourth read semaphore S14R becomes at least “1” (“Wait” in the decoding state ST2). When the fourth read semaphore S14R becomes at least “1” due to a V operation by the quantization operation circuit 5, the convolution operation circuit 4 initiates a convolution operation.

By using the fourth semaphores S14, the quantization operation circuit 5 in the second NN operation core 10B and the convolution operation circuit 4 in the first NN operation core 10A can prevent competition for access to the first memory 1 in the fourth data flow F14. Additionally, by using the fourth semaphores S14, the quantization operation circuit 5 in the second NN operation core 10B and the convolution operation circuit 4 in the first NN operation core 10A can operate independently and in parallel while synchronizing data transfer between multiple NN operation cores 10 in the fourth data flow F14.

The first memory 1 in the first NN operation core 10A is shared by the three data flows (the first data flow F11, the third data flow F13, and the fourth data flow F14). By providing the first semaphores S11, the third semaphores S13, and the fourth semaphores S14 separately, the NN circuit 100 can synchronize data transfer by distinguishing between the first data flow F11, the third data flow F13, and the fourth data flow F14.

### [First Data Flow F21 in Second NN Operation Core 10B]

The first data flow F21 in the second NN operation core 10B is the same as the first data flow F1i in the first NN operation core 10A. By using the first semaphores S21, the first DMAC 3 and the convolution operation circuit 4 in the second NN operation core 10B can prevent competition for access to the first memory 1 in the first data flow F21. Additionally, by using the first semaphores S21, the first DMAC 3 and the convolution operation circuit 4 in the second NN operation core 10B can operate independently and in parallel while synchronizing data transfer in the first data flow F21 in the second NN operation core 10B.

### [Second Data Flow F22 in Second NN Operation Core 10B]

The second data flow F22 in the second NN operation core 10B is the same as the second data flow F12 in the first NN operation core 10A. By using the second semaphores S22, the convolution operation circuit 4 in the second NN operation core 10B and the quantization operation circuit 5 in the second NN operation core 10B can prevent competition for access to the second memory 2 in the second data flow F22. Additionally, by using the second semaphores S22, the convolution operation circuit 4 in the second NN operation core 10B and the quantization operation circuit 5 in the second NN operation core 10B can operate independently and in parallel while synchronizing data transfer in the second data flow F22.

### [Third Data Flow F23 in Second NN Operation Core 10B]

The third data flow F23 in the second NN operation core 10B is the same as the third data flow F13 in the first NN operation core 10A. By using the third semaphores S23, the quantization operation circuit 5 in the second NN operation core 10B and the convolution operation circuit 4 in the second NN operation core 10B can prevent competition for access to the first memory 1 in the third data flow F23. Additionally, by using the third semaphores S23, the quantization operation circuit 5 in the second NN operation core 10B and the convolution operation circuit 4 in the second NN operation core 10B can operate independently and in parallel while synchronizing data transfer in the third data flow F23.

### [Fourth Data Flow F24 in Second NN Operation Core 10B]

The fourth data flow F24 in the second NN operation core 10B is the same as the fourth data flow F14 in the first NN operation core 10A. By using the fourth semaphores S24, the quantization operation circuit 5 in the first NN operation core 10A and the convolution operation circuit 4 in the second NN operation core 10B can prevent competition for access to the first memory 1 in the fourth data flow F24. Additionally, by using the fourth semaphores S24, the quantization operation circuit 5 in the first NN operation core 10A and the convolution operation circuit 4 in the second NN operation core 10B can operate independently and in parallel while synchronizing data transfer between multiple NN operation cores 10 in the fourth data flow F24.

### [Operations of Convolution Operation Circuit 4 in First NN Operation Core 10A]

When performing a convolution operation, the convolution operation circuit 4 in the first NN operation core 10A reads from the first memory 1 in the first NN operation core 10A and writes into the second memory 2 in the first NN operation core 10A. That is, the convolution operation circuit 4 is a Consumer for three data flows (the first data flow F11, the third data flow F13, and the fourth data flow F14) and is a Producer for the second data flow F12. Therefore, when initiating a convolution operation, the convolution operation circuit 4 performs a P operation with respect to the read semaphore corresponding to the data flow (the first read semaphore S11R, the third read semaphore S13R, or the fourth read semaphore S14R) (see FIG. 24, FIG. 26, and FIG. 27), and performs a P operation with respect to the second write semaphore S12W (see FIG. 24). After the convolution operation has been completed, the convolution operation circuit 4 performs a V operation with respect to the write semaphore corresponding to the data flow (the first write semaphore S11W, the third write semaphore S13W, or the fourth write semaphore S14W) (see FIG. 24, FIG. 26, and FIG. 27), and performs a V operation with respect to the second read semaphore S12R (see FIG. 25).

When initiating a convolution operation, the convolution operation circuit 4 in the first NN operation core 10A must wait until the read semaphore corresponding to the data flow (the first read semaphore S11R, the third read semaphore S13R, or the fourth read semaphore S14R) becomes at least “1” and the second write semaphore S12W becomes at least “1” (“Wait” in the decoding state ST2).

### [Operations of Quantization Operation Circuit 5 in First NN Operation Core 10A]

When performing a quantization operation, the quantization operation circuit 5 in the first NN operation core 10A reads from the second memory 2 in the first NN operation core 10A and writes into the first memory 1 in the first NN operation core 10A or the first memory 1 in the second NN operation core 10B. That is, the quantization operation circuit 5 is a Consumer for the second data flow F12 and is a Producer for two data flows (the third data flow F13 and the fourth data flow F24). Therefore, when initiating a quantization operation, the quantization operation circuit 5 performs a P operation with respect to the second read semaphore S12R (see FIG. 25), and performs a P operation with respect to the write semaphore corresponding to the data flow (the third write semaphore S13W or the fourth write semaphore S24W) (see FIG. 26). After the quantization operation has been completed, the quantization operation circuit 5 performs a V operation with respect to the second write semaphore S12W (see FIG. 25), and performs a V operation with respect to the read semaphore corresponding to the data flow (the third read semaphore S13R or the fourth read semaphore S24R) (see FIG. 26).

When initiating a quantization operation, the quantization operation circuit 5 in the first NN operation core 10A must wait until the second read semaphore S12R becomes at least “1” and the write semaphore corresponding to the data flow (the third write semaphore S13W or the fourth write semaphore S24W) becomes at least “1” (“Wait” in the decoding state ST2).

The quantization operation circuit 5 in the first NN operation core 10A can change the first memory 1 in which the quantization operation output data is to be stored by switching between the third data flow F13 and the fourth data flow F24. The quantization operation circuit 5 in the second NN operation core 10B can similarly change the first memory 1 in which the quantization operation output data is to be stored by switching between the third data flow F23 and the fourth data flow F14.

With the neural network circuit 100 according to the present embodiment, the NN circuit 100, in which embedded devices such as IoT devices are embeddable, can operate with high performance. By connecting multiple NN operation cores 10, more neural network operations can be implemented efficiently and at a high speed.

While a first embodiment of the present invention has been described in detail with reference to the drawings above, the specific structure is not limited to this embodiment, and design changes or the like within a range not departing from the spirit of the present invention are also included. Additionally, the structural elements indicated in the above embodiment and the modified examples may be combined as appropriate.

### Second Embodiment

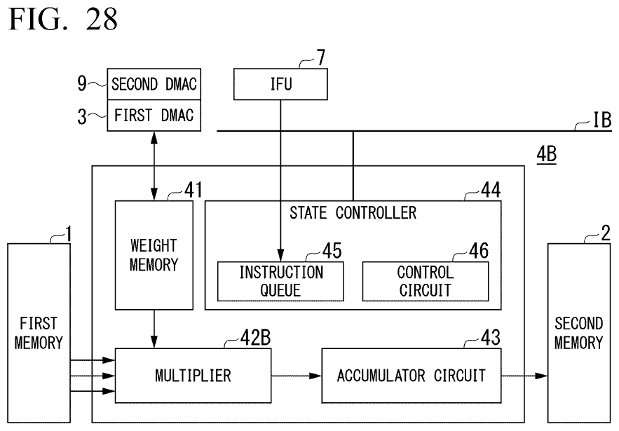

A second embodiment of the present invention will be explained with reference to FIG. 28 to FIG. 31. In the explanation below, the features that are the same as those that have already been explained will be assigned the same reference numbers and redundant explanations will be omitted. In the neural network circuit 100B (hereinafter also referred to as “NN circuit 100B”) according to the second embodiment, the convolution operation circuits 4 are different compared to those in the neural network circuit 100 according to the first embodiment.

### [NN Circuit 100B]

The NN circuit 100B is provided with a first DMAC 3, a controller 6, an IFU 7, a shared memory 8, a second DMAC 9, and at least one neural network operation core 10E (hereinafter also referred to as “NN operation core 10E”).

### [NN Operation Core 10E]

The NN operation core 10E is provided with a first memory 1, a second memory 2, a convolution operation circuit 4B, and a quantization operation circuit 5.

### [Convolution Operation Circuit 4B]

The convolution operation circuit 4B is a circuit that performs a convolution operation in a convolution layer 210 in a trained CNN 200. The convolution operation circuit 4B reads input data a stored in the first memory 1 and implements a convolution operation on the input data a. The convolution operation circuit 4B writes convolution operation output data into the second memory 2.

FIG. 28 is an internal block diagram of the convolution operation circuit 4B.

The convolution operation circuit 4B has a weight memory 41, a multiplier 42B, an accumulator circuit 43, and a state controller 44.

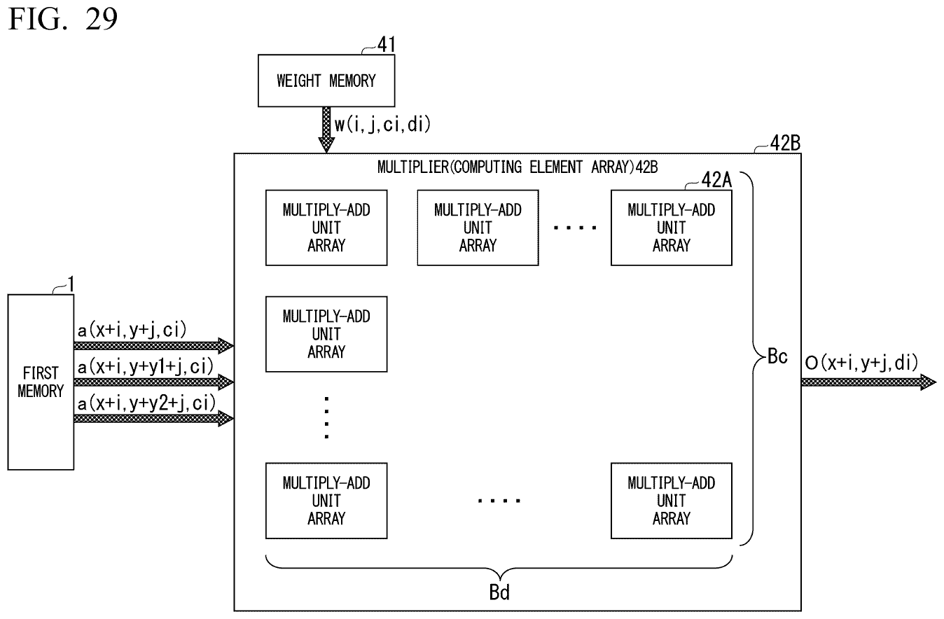

FIG. 29 is an internal block diagram of the multiplier 42.

The multiplier (computing element array) 42B multiplies the respective elements a(x+i, y+j, ci) of partitioned input data a(x+i, y+j, co) with the respective elements w(i, j, ci, di) of partitioned weights w(i, j, co, do). The multiplier 42 has a Bc×Bd multiply-add operation unit array 42A, and can implement, in parallel, multiplication between the elements a(x+i, y+j, ci) of the partitioned input data a(x+i, y+j, co) and the elements w(i, j, ci, di) of the partitioned weights w(i, j, co, do).

The multiplier (computing element array) 42B implements the multiplication by reading out the elements a and the elements w necessary for multiplication from the first memory 1 and the weight memory 41. The multiplier 42 outputs Bd multiply-add operation results O(x+i, y+j, di).

The number of the multiply-add operation unit array 42A included in the multiplier 42 is not limited to Bc×Bd. For example, the number of the multiply-add operation unit array 42A may be (Bc/P)×Bd (P is Bc or a divisor of Bc). In this case, the multiply-add operation unit array 42A partitions the partitioned input data a(x+i, y+j, co) into sets of P in the c-axis direction.

The multiplier (computing element array) 42B reads out the elements a(x+i, y+j, ci), the elements a(x+i, y+y1+j, ci), and the elements a(x+i, y+y2+j, ci) from the first memory 1 (0<y1<y2). When y1=1 and y2=2, the three sets of elements a are data from consecutive lines in the y-axis direction on the xy-axial plane. When y1=1+ST and y2=2+2ST, the three sets of elements a are data from lines separated by ST lines in the y-axis direction (ST is a stride in the y-axis direction). The multiplier (computing element array) 42B may have a line memory for storing the elements a.

The first memory 1 is preferably a multi-bank memory. In this case, the elements a(x+i, y+j, ci), the elements a(x+i, y+y1+j, ci), and the elements a(x+i, y+y2+j, ci) are stored in different banks and the respective elements are read out independently at a high speed.

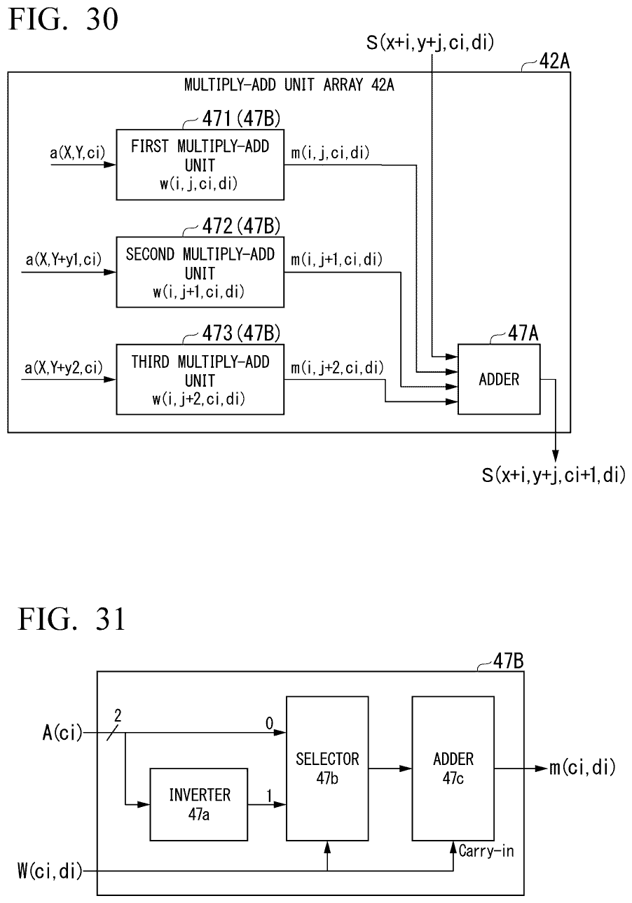

FIG. 30 is an internal block diagram of the multiply-add operation unit array 42A.

The multiply-add operation unit array 42A multiplies the elements a with the elements w. The multiply-add operation unit array 42A has three multiply-add operation units 47B. In the explanation below, the three multiply-add operation units 47B will be referred to as a first multiply-add operation unit 471, a second multiply-add operation unit 472, and a third multiply-add operation unit 473.

FIG. 31 is an internal block diagram of a multiply-add operation unit 47B.

The multiply-add operation unit 47B multiplies an element A(ci) of the input vector A with an element W(ci, di) of the weight matrix W. The multiply-add operation unit 47 outputs multiplication results s(ci). The elements A(ci) are 2-bit unsigned integers (0, 1, 2, 3). The elements W(ci, di) are 1-bit signed integers (0, 1), where the value “0” represents +1 and the value “1” represents −1.

The multiply-add operation unit 47B has an inverter 47a, a selector 47b, and an adder 47c. The multiply-add operation unit 47 performs multiplication using only the inverter 47a and the selector 47b, without using a multiplier. If the element W(ci, di) is “0”, then the selector 47b selects to input the element A(ci). If the element W(ci, di) is “1”, then the selector 47b selects a complement obtained by inverting the element A(ci) with the inverter. The element W(ci, di) is also input to the Carry-in of the adder 47c. If the element W(ci, di) is “0”, then the adder 47c outputs the value obtained by adding the element A(ci) to m(ci, di). If W(ci, di) is “1”, then the adder 47c outputs the value obtained by subtracting the element A(ci) from m(ci, di).

The first multiply-add operation unit 471 multiplies the element a(X, Y, ci) with the element w(i, j, ci, di) (X is an arbitrary x coordinate included in the input data a and Y is an arbitrary y coordinate included in the input data a). The first multiply-add operation unit 471 outputs the output m(i, j, ci, di) to the adder 47A.

The second multiply-add operation unit 472 multiplies the element a(X, Y+y1, ci) with the element w(i, j+1, ci, di). The second multiply-add operation unit 472 outputs the output m(i, j+1, ci, di) to the adder 47A.

The third multiply-add operation unit 473 multiplies the element a(X, Y+y2, ci) with the element w(i, j+2, ci, di). The third multiply-add operation unit 473 outputs the output m(i, j+2, ci, di) to the adder 47A.

The adder 47A adds the output m(i, j, ci, di), the output m(i, j+1, ci, di), the output m(i, j+2, ci, di), and the multiplication result S(x+i, y+j, ci, di) from another multiply-add operation unit 47B, and outputs the addition result S(x+i, y+j, ci+1, di).

With the neural network circuit 100B according to the present embodiment, operations can be performed in parallel by the multiply-add operation unit array 42A, and high-speed convolution operations are made possible. The neural network circuit 100B can favorably implement convolution operations even when there are two or more strides ST in the y-axis direction in the convolution operations.

While a second embodiment of the present invention has been described in detail with reference to the drawings above, the specific structure is not limited to this embodiment, and design changes or the like within a range not departing from the spirit of the present invention are also included. Additionally, the structural elements indicated in the above embodiment and the modified examples may be combined as appropriate.

### Third Embodiment

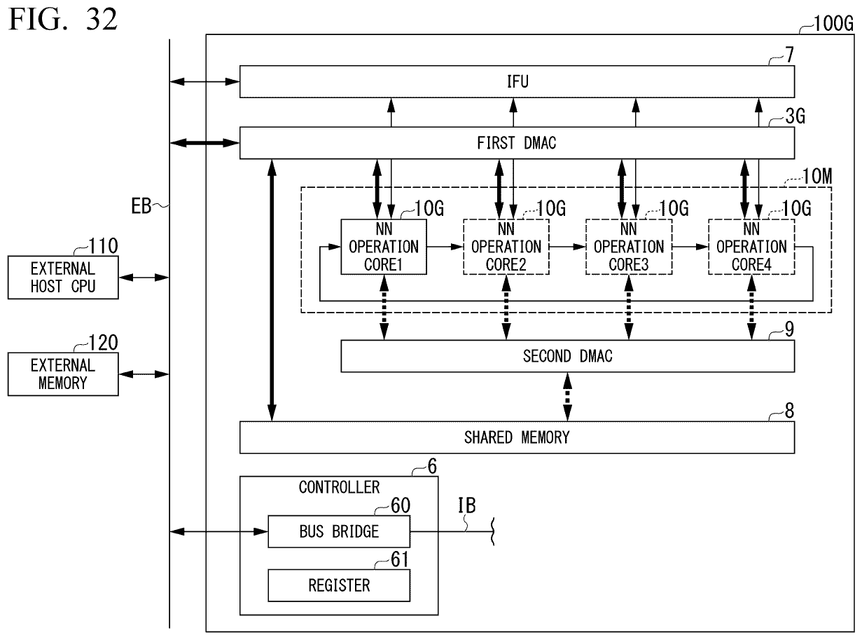

A third embodiment of the present invention will be explained with reference to FIG. 32 to FIG. 36. In the explanation below, the features that are the same as those that have already been explained will be assigned the same reference numbers and redundant explanations will be omitted. The neural network circuit 100G (hereinafter also referred to as “NN circuit 100G”) according to the third embodiment further has a clock gating function and a power gating function in comparison with the neural network circuit 100 according to the first embodiment.

### [NN Circuit 100G]

FIG. 32 is a diagram illustrating the overall structure of the NN circuit 100G according to the present embodiment.

The NN circuit 100G is provided with a first DMAC 3G, a controller 6, an IFU 7, a shared memory 8, a second DMAC 9, and at least one neural network operation core 10G (hereinafter also referred to as “NN operation core 10G”). The NN circuit 100G need not have the shared memory 8 and the second DMAC 9.

Multiple NN operation cores 10G can be mounted on the NN circuit 100G. In the NN circuit 100G indicated in FIG. 32, a maximum of four NN operation cores 10G can be mounted. The multiple NN operation cores 10G, as in the NN operation cores 10 in the first embodiment, form an “NN operation multi-core 10M” that cooperate to execute at least some of the operations of the NN 200. The multiple NN operation cores 10G are connected in a daisy chain, as in the first embodiment. The number of NN operation cores 10 that can be mounted on the NN circuit 100G is not limited to four.

### [First DMAC 3G]

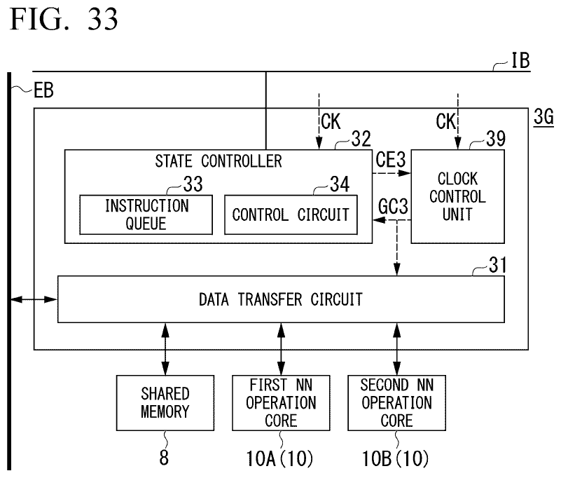

FIG. 33 is an internal block diagram of the first DMAC 3G.

The first DMAC 3G, like the first DMAC 3 in the first embodiment, is connected to an external bus EB and transfers data between an external memory 120, such as a DRAM, and the NN operation cores 10G. The first DMAC 3G has a data transfer circuit 3, a state controller 32, and a clock control unit 39.

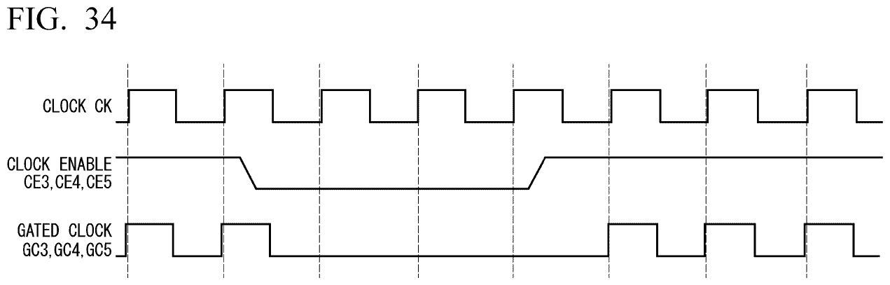

FIG. 34 is a timing chart indicating the operations of the clock control unit 39.

The clock control unit 39, based on a clock enable signal CE3, generates a gated clock (third clock) GC3 from a clock CK supplied to the NN circuit 100G. When the clock enable signal CE3 is negated and set to disable (Disable; Low in FIG. 34), the toggling of the gated clock GC3 is stopped. When the clock enable signal CE3 is asserted and set to enable (Enable; High in FIG. 34), the toggling of the gated clock GC3 is started. The generation circuit for the gated clock GC3 is a circuit appropriately selected from among known clock gating circuits.

The clock enable signal CE3 is controlled by the state controller 32. When an operation of the data transfer circuit 31 indicated by an instruction command C3 has been determined to be non-executable while in the decoding state ST2, the control circuit 34 of the state controller 32 waits until the operation becomes executable (Wait). In the time period during which the control circuit 34 is waiting until the above-mentioned operation becomes executable, the control circuit 34 negates the clock enable signal CE3 and sets it to disable (Disable). As a result thereof, the toggling of the gated clock GC3 is stopped. When the above-mentioned operation becomes executable and the control circuit 34 of the state controller 32 transitions from the decoding state ST2 to the execution state ST3, the control circuit 34 asserts the clock enable signal CE3 and sets it to enable (Enable). As a result thereof, when the control circuit 34 is in the execution state ST3, the toggling of the gated clock GC3 is resumed.

The gated clock GC3 that has been generated is output to a portion of the state controller 32 and to the data transfer circuit 31, as indicated in FIG. 33, and is used as an operation clock.

The clock control unit 39 may, in the idle state ST1, negate the clock enable signal CE3 and set it to disable. Furthermore, the control circuit 34 may, in the idle state ST1, stop supplying power (power gating) to the circuit to which the gated clock GC3 is provided, thus transitioning to a power-saving mode.

### [NN Operation Core 10G]

The NN operation core 10G is provided with a first memory 1, a second memory 2, a convolution operation circuit 4G and a quantization operation circuit 5G.

### [Convolution Operation Circuit 4G]

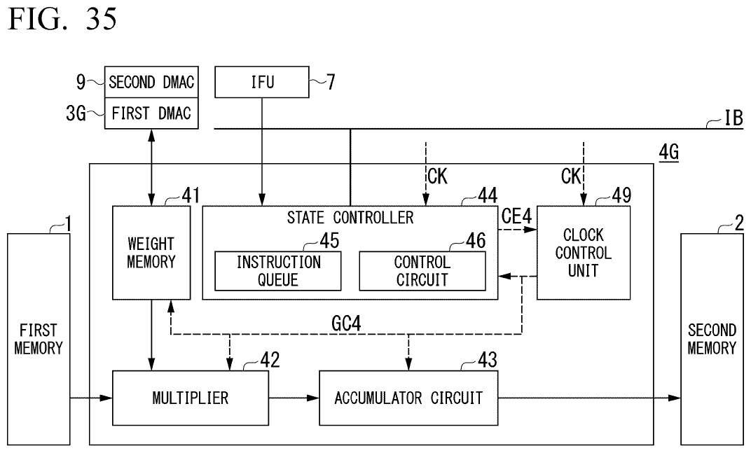

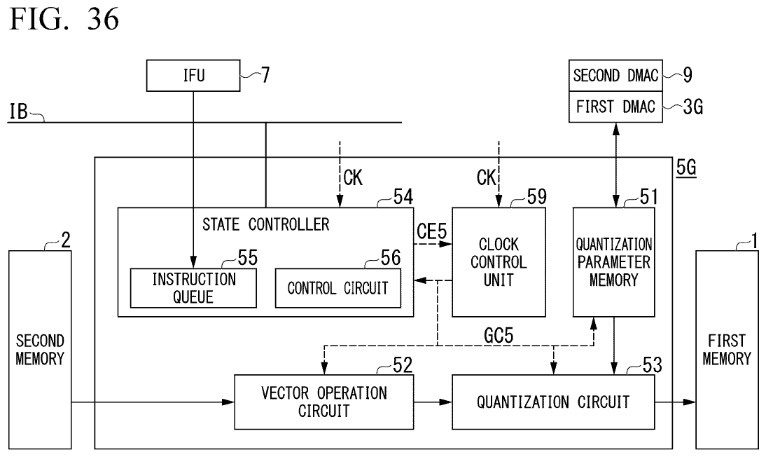

FIG. 35 is an internal block diagram of the convolution operation circuit 4G.

The convolution operation circuit 4G has a weight memory 41, a multiplier 42, an accumulator circuit 43, a state controller 44, and a clock control unit 49.

The clock control unit 49, based on a clock enable signal CE4, generates a gated clock (first clock) GC4 from the clock CK supplied to the NN circuit 100G. As indicated in FIG. 34, when the clock enable signal CE4 is negated and set to disable (Disable), the toggling of the gated clock GC4 is stopped. When the clock enable signal CE4 is asserted and set to enable (Enable), the toggling of the gated clock GC4 is started. The clock control unit 49 has a structure similar to the clock control unit 39 in the first DMAC 3.

The clock enable signal CE4 is controlled by the state controller 44. When an operation of the multiplier 42, the accumulator circuit 43, etc. indicated by an instruction command C4 has been determined to be non-executable while in the decoding state ST2, the control circuit 46 of the state controller 44 waits until the operation becomes executable (Wait). In the time period during which the control circuit 46 is waiting until the above-mentioned operation becomes executable, the control circuit 46 negates the clock enable signal CE4 and sets it to disable (Disable). As a result thereof, the toggling of the gated clock GC4 is stopped. When the above-mentioned operation becomes executable and the control circuit 46 of the state controller 44 transitions from the decoding state ST2 to the execution state ST3, the control circuit 46 asserts the clock enable signal CE4 and sets it to enable (Enable). As a result thereof, when the control circuit 46 is in the execution state ST3, the toggling of the gated clock GC4 is resumed.

The gated clock GC4 that has been generated is output to a portion of the state controller 44, the weight memory 41, the multiplier 42, and the accumulator circuit 43, as indicated in FIG. 35, and is used as an operation clock.

The clock control unit 49 may, in the idle state ST1, negate the clock enable signal CE4 and set it to disable. Furthermore, the control circuit 46 may, in the idle state ST1, stop supplying power (power gating) to the circuit to which the gated clock GC4 is provided, thus transitioning to a power-saving mode.

### [Quantization Operation Circuit 5G]

FIG. 36 is an internal block diagram of the quantization operation circuit 5G.

The quantization operation circuit 5G has a quantization parameter memory 51, a vector operation circuit 52, a quantization circuit 53, a state controller 54, and a clock control unit 59.

The clock control unit 59, based on a clock enable signal CE5, generates a gated clock (third clock) GC5 from the clock CK supplied to the NN circuit 100G. As indicated in FIG. 34, when the clock enable signal CE5 is negated and set to disable (Disable), the toggling of the gated clock GC5 is stopped. When the clock enable signal CE5 is asserted and set to enable (Enable), the toggling of the gated clock GC5 is started. The clock control unit 59 has a structure similar to the clock control unit 39 in the first DMAC 3.

The clock enable signal CE5 is controlled by the state controller 54. When an operation of the vector operation circuit 52, the quantization circuit 53, etc. indicated by an instruction command C5 has been determined to be non-executable while in the decoding state ST2, the control circuit 56 of the state controller 54 waits until the operation becomes executable (Wait). In the time period during which the control circuit 56 is waiting until the above-mentioned operation becomes executable, the control circuit 56 negates the clock enable signal CE5 and sets it to disable (Disable). As a result thereof, the toggling of the gated clock GC5 is stopped. When the above-mentioned operation becomes executable and the control circuit 56 of the state controller 54 transitions from the decoding state ST2 to the execution state ST3, the control circuit 56 asserts the clock enable signal CE5 and sets it to enable (Enable). As a result thereof, when the control circuit 56 is in the execution state ST3, the toggling of the gated clock GC5 is resumed.

The gated clock GC5 that has been generated is output to a portion of the state controller 54, the quantization parameter memory 51, the vector operation circuit 52 and the quantization circuit 53, as indicated in FIG. 36, and is used as an operation clock.

The clock control unit 59 may, in the idle state ST1, negate the clock enable signal CE5 and set it to disable. Furthermore, the control circuit 56 may, in the idle state ST1, stop supplying power (power gating) to the circuit to which the gated clock GC5 is provided, thus transitioning to a power-saving mode.

With the neural network circuit 100G according to the present embodiment, power consumption can be reduced by means of clock gating and power gating. The first DMAC 3G, the convolution operation circuit 4G, and the quantization operation circuit 5G each implement clock gating and power gating independently.

While a third embodiment of the present invention has been described in detail with reference to the drawings above, the specific structure is not limited to this embodiment, and design changes or the like within a range not departing from the spirit of the present invention are also included. Additionally, the structural elements indicated in the above embodiment and the modified examples may be combined as appropriate.

### Fourth Embodiment

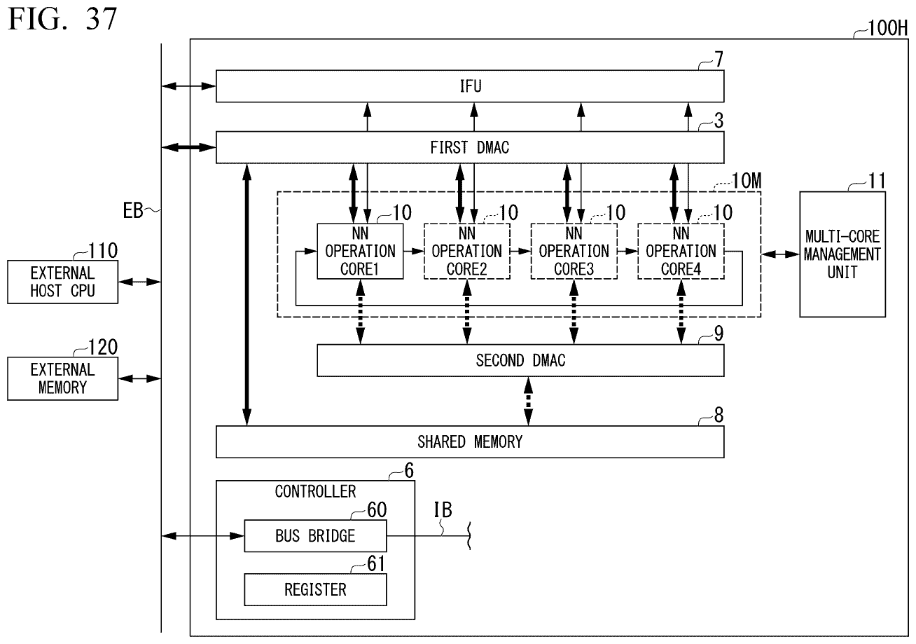

A fourth embodiment of the present invention will be explained with reference to FIG. 37. In the explanation below, the features that are the same as those that have already been explained will be assigned the same reference numbers and redundant explanations will be omitted. The neural network circuit 100H (hereinafter also referred to as “NN circuit 100H”) according to the fourth embodiment further has a multi-core management unit 11 in comparison with the neural network circuit 100 according to the first embodiment.

### [NN Circuit 100H]

FIG. 37 is a diagram illustrating the overall structure of the NN circuit 100H according to the present embodiment.

The NN circuit 100H is provided with a first DMAC 3, a controller 6, an IFU 7, a shared memory 8, a second DMAC 9, at least one NN operation core 10, and a multi-core management unit 11.

The multi-core management unit 11 monitors the state of the NN operation multi-core 10M and manages clocks and power supplied to the NN operation cores 10. Clocks and power are supplied to the NN operation cores 10 that are operating in the NN operation multi-core 10M, and clocks and power are not supplied to at least some of the NN operation cores 10 that are not operating. That is, the multi-core management unit 11 implements at least one of clock gating and power gating for each NN operation core 10 in accordance with the operating conditions of the NN operation cores 10. By mounting multiple NN operation cores 10, the NN circuit 100H can improve the operational performance and can favorably suppress the increase of power consumption associated with increased circuit size.

The multi-core management unit 11 may be able to forcibly select an NN operation core 10 that is able to operate. For example, the multi-core management unit 11 sets some of the NN operation cores 10 to be able to operate, and sets other NN operation cores 10 to be incapable of operating. The multi-core management unit 11 stops supplying clocks and power to the NN operation cores 10 that have been set to be incapable of operating. By limiting the NN operation cores 10 that are able to operate, the multi-core management unit 11 can reduce power consumption, albeit with a decrease in operational performance. Additionally, by setting all of the NN operation cores 10 to be able to operate, the multi-core management unit 11 can improve the operational performance, albeit with an increase in power consumption.

With the neural network circuit 100H according to the present embodiment, the power consumption can be reduced by clock gating and power gating. The multi-core management unit 11 implements clock gating and power gating independently for each NN operation core 10.

The NN circuit 100H may also implement the clock gating and power gating implemented by the first DMAC 3G, the convolution operation circuit 4G and the quantization operation circuit 5G in the third embodiment.

While a fourth embodiment of the present invention has been described in detail with reference to the drawings above, the specific structure is not limited to this embodiment, and design changes or the like within a range not departing from the spirit of the present invention are also included. Additionally, the structural elements indicated in the above embodiment and the modified examples may be combined as appropriate.

### Modified Example 1

In the above embodiments, the multiple NN operation cores 10 were connected in a daisy chain. However, the mode of connection of the multiple NN operation cores 10 is not limited thereto. The NN operation cores 10 need only be connected so as to be able to input and output data with respect to at least one other NN operation core 10. Even in the case in which the mode of connection of the multiple NN operation cores 10 is different, the NN circuit 100 is controlled by using semaphores S provided for each data flow.

### Modified Example 2

In the above embodiments, the first memory 1 and the second memory 2 were separate memories. However, the first memory 1 and the second memory 2 are not limited to such an embodiment. The first memory 1 and the second memory 2 may, for example, be a first memory area and a second memory area in the same memory.

### Modified Example 3

In the above embodiments, semaphores S were provided for the first data flow (F11, F21), the second data flow (F12, F22), the third data flow (F13, F23), and the fourth data flow (F14, F24). However, the semaphores S are not limited to such an embodiment. Semaphores S may, for example, be provided for a data flow by which the first DMAC 3 writes the weights w into the weight memory 41 and the multiplier 42 reads the weights w. Semaphores S may, for example, be provided for a data flow by which the first DMAC 3 writes quantization parameters q into the quantization parameter memory 51 and the quantization circuit 53 reads the quantization parameters q.

### Modified Example 4

For example, the data input to the NN circuit 100 described in the above embodiment need not be limited to a single form, and may be composed of still images, moving images, audio, text, numerical values, and combinations thereof. The data input to the NN circuit 100 is not limited to being measurement results from a physical amount measuring device such as an optical sensor, a thermometer, a Global Positioning System (GPS) measuring device, an angular velocity measuring device, a wind speed meter, or the like that can be installed in an edge device in which the NN circuit 100 is provided. The data may be combined with different information such as base station information received from a peripheral device by cable or wireless communication, information from vehicles, ships or the like, weather information, peripheral information such as information relating to congestion conditions, financial information, personal information, or the like.

### Modified Example 5

While the edge device in which the NN circuit 100 is provided is contemplated as being a device that is driven by a battery or the like, as in a communication device such as a mobile phone or the like, a smart device such as a personal computer, a digital camera, a game device, or a mobile device in a robot product or the like, the edge device is not limited thereto. Effects not obtained by other prior examples can be obtained by utilization in products for which there is a demand for long-term driving or for reducing product heat generation, or for restricting the peak electric power that can be supplied by Power on Ethernet (PoE) or the like. For example, by applying the invention to an on-board camera mounted on a vehicle, a ship, or the like, or to a security camera provided in a public facility or on a road, not only can long-term image capture be realized, but also, the invention can contribute to weight reduction and higher durability. Additionally, similar effects can be achieved by applying the invention to a display device on a television, a monitor, or the like, to a medical device such as a medical camera or a surgical robot, or to a working robot used at a production site or at a construction site.

### Modified Example 6

The NN circuit 100 may be realized by using one or more processors for part of or for the entirety of the NN circuit 100. For example, in the NN circuit 100, some or all of the input layer or the output layer may be realized by software processes in a processor. Some of the input layer or the output layer realized by software processes consists, for example, of data normalization and conversion. As a result thereof, the invention can handle various types of input formats or output formats. The software executed by the processor may be configured so as to be rewritable by using a communication means or external media.

### Modified Example 7

The NN circuit 100 may be realized by combining some of the processes in the CNN 200 with a Graphics Processing Unit (GPU) or the like on a cloud server. The NN circuit 100 can realize more complicated processes with fewer resources by performing further cloud-based processes in addition to the processes performed by the edge device in which the NN circuit 100 is provided, or by performing processes on the edge device in addition to the cloud-based processes. With such a configuration, the NN circuit 100 can reduce the amount of communication between the edge device and the cloud by means of processing distribution.

Additionally, the effects described in the present specification are merely explanatory or exemplary, and are not limiting. In other words, the features in the present disclosure may, in addition to the effects mentioned above or instead of the effects mentioned above, have other effects that would be clear to a person skilled in the art from the descriptions in the present specification.

### INDUSTRIAL APPLICABILITY

The present invention can be applied to neural network operations.

### REFERENCE SIGNS LIST

200 Convolutional neural network
100, 100B, 100G, 100H Neural network circuit (NN circuit)
10, 10G Neural network operation core (NN operation core)
10A First neural network operation core (first NN operation core)
10B Second neural network operation core (second NN operation core)
10M Neural network operation multi-core (NN operation multi-core)
11 Multi-core management unit
1 First memory
2 Second memory
3, 3G First DMA controller (first DMAC)
4, 4B, 4G Convolution operation circuit
42, 42B Multiplier
43 Accumulator circuit
49 Clock control unit
5, 5G Quantization operation circuit
52 Vector operation circuit
53 Quantization circuit
59 Clock control unit
6 Controller
61 Register
7 IFU
8 Shared memory
9 Second DMA controller (second DMAC)
S Semaphore
S1 First semaphore
S11R, S21R First read semaphore
S11W, S21W First write semaphore
S2 Second semaphore
S12R, S22R Second read semaphore
S12W, S22W Second write semaphore
S3 Third semaphore
S13R, S23R Third read semaphore
S13W, S23W Third write semaphore
S4 Fourth semaphore
S14R, S24R Fourth read semaphore
S14W, S24W Fourth write semaphore
F11, F21 First data flow
F12, F22 Second data flow
F13, F23 Third data flow (loop-back data flow)
F14, F24 Fourth data flow (bypass data flow)

1. A neural network circuit comprising multiple neural network operation cores having-comprising convolution operation circuits that perform convolution operations and quantization operation circuits that perform quantization operations, wherein:
the multiple neural network operation cores are connected so as to be able to input and output data.

2. The neural network circuit according to claim 1, wherein the multiple neural network operation cores are connected in a daisy chain.

3. The neural network circuit according to claim 1, wherein:
the neural network operation cores other than in a final stage are connected to the neural network operation cores in a subsequent stage; and
the neural network operation core in the final stage is connected to the neural network operation core in a first stage.

4. The neural network circuit according to claim 1, wherein
the neural network operation cores comprise:
first memories that store input data input to the convolution operation circuits; and
second memories that store convolution operation output data from the convolution operation circuits, wherein
quantization operation output data from the quantization operation circuits is stored in the first memory, and
the quantization operation output data stored in the first memories are input, as the input data, to the convolution operation circuits.

5. The neural network circuit according to claim 4, wherein
in a first neural network operation core and a second neural network operation core, which are the neural network operation cores,
the quantization operation output data of the quantization operation circuit in the first neural network operation core can be stored in the first memory in the second neural network operation core.

6. The neural network circuit according to claim 5, wherein
in the neural network operation cores, the first memories, the convolution operation circuits, the second memories, and the quantization operation circuits are formed in the form of a loop.

7. The neural network circuit according to claim 6, wherein the first memories, the convolution operation circuits, the second memories, and the quantization operation circuits are connected so as to be repeatedly arrayed in the same order.

8. The neural network circuit according to claim 6, comprising:
a third semaphore that controls a data flow by which the quantization operation circuit in the first neural network operation core writes the quantization operation output data into the first memory in the first neural network operation core, and the convolution operation circuit in the first neural network operation core reads the quantization operation output data; and
a fourth semaphore that controls a data flow by which the quantization operation circuit in the second neural network operation core writes the quantization operation output data into the first memory in the first neural network operation core, and the convolution operation circuit in the first neural network operation core reads the quantization operation output data.

9. The neural network circuit according to claim 1, wherein
the convolution operation circuits, when waiting to execute the convolution operations, enable clock gating of a first clock supplied to at least some of the convolution operation circuits.

10. The neural network circuit according to claim 1, wherein
the quantization operation circuits, when waiting to execute the quantization operations, enable clock gating of a second clock supplied to at least some of the quantization operation circuits.

11. The neural network circuit according to claim 1, further comprising:
a multi-core management unit that manages the clocks supplied to each of the multiple neural network operation cores.

12. A neural network operation method using a first neural network operation core and a second neural network operation core, the neural network operation method including:
switching output data from the first neural network operation core between a loop-back data flow for looping back to the first neural network operation core, and a bypass data data flow for bypassing the second neural network operation core.
